(19) United States
(12) Patent Application Publication
(10) Pub. No.: US 2026/0129334 A1
(43) Pub. Date: May 7, 2026

(54) EARPHONES

(71) Applicant: SHENZHEN SHOKZ CO., LTD., Shenzhen (CN)

(72) Inventors: Lei ZHONG, Shenzhen (CN); Haochen LIU, Shenzhen (CN); Shiyu YU, Shenzhen (CN); Jiang XU, Shenzhen (CN); Weijie YUAN, Shenzhen (CN); Xiaobang WEN, Shenzhen (CN)

(73) Assignee: SHENZHEN SHOKZ CO., LTD., Shenzhen (CN)

(21) Appl. No.: 19/437,211

(22) Filed: Dec. 30, 2025

Related U.S. Application Data
(63) Continuation of application No. PCT/CN2024/134010, filed on Nov. 22, 2024.

(30) Foreign Application Priority Data
Dec. 11, 2023 (CN) 202311701969.7
Feb. 6, 2024 (WO) PCT/CN2024/076495

(51) Int. Cl. H04R 1/10

(52) U.S. Cl. CPC H04R 1/1016; H04R 1/105

(57) ABSTRACT

The present disclosure relates to an earphone, including: a sound-generating portion; an abutment portion; and an ear hook. The ear hook includes an elastic metal member. In a reference cross-section along a length direction of the ear hook and in a natural state of the earphone, the elastic metal member includes an elastic segment. The elastic segment is divided into a first sub-elastic segment and a second sub-elastic segment that are arranged in an arc shape and connected to each other. A curvature radius of at least a portion of the first sub-elastic segment starting from the connection point and a curvature radius of at least a portion of the second sub-elastic segment starting from the connection point gradually increase. A length of the first sub-elastic segment is greater than a length of the second sub-elastic segment.

### CROSS-REFERENCE TO RELATED APPLICATIONS

This application is a continuation of International Patent Application No. PCT/CN 2024/134010, filed on Nov. 22, 2024, which claims priority to Chinese Patent Application No. 202311701969.7, filed on Dec. 11, 2023, and priority to International Patent Application No. PCT/CN 2024/076495, filed on Feb. 6, 2024, the entire contents of each of which are incorporated herein by reference.

### TECHNICAL FIELD

The present disclosure relates to the field of electronic devices, and in particular, to an earphone.

### BACKGROUND

With the widespread adoption of electronic devices, they have become indispensable tools for social interaction and entertainment in the daily lives of people, leading to increasingly higher user expectations. As a category of such devices, earphones have also seen widespread use in daily life, and are able to be used in conjunction with terminal devices such as mobile phones and computers to provide users with an auditory feast. According to the working principle of the earphones, the earphones may be generally divided into air-conduction earphones and bone-conduction earphones. According to the way users wear the earphones, the earphones may be generally divided into over-ear earphones, ear-hook earphones, and in-ear earphones. According to the interaction manner between the earphones and the electronic devices, the earphones may also be generally divided into wired earphones and wireless earphones. Most current ear-hook earphones generally have poor wearing stability. However, the wearing stability of the earphones is an important evaluation indicator for users when experiencing the earphones. Therefore, how to improve the wearing stability of the ear-hook earphones is an urgent problem that needs to be solved at present.

### SUMMARY

One or more embodiments of the present disclosure provide an earphone. The earphone includes a sound-generating portion configured to convert an electrical signal into a sound signal and play the sound signal; an abutment portion provided with a battery; and an ear hook connecting the sound-generating portion and the abutment portion. In a wearing state of the earphone, the sound-generating portion and the abutment portion form a clamping state on two sides of a helix of a user, the sound-generating portion is located within a cavum conchae of the user. The ear hook includes an elastic metal member. In a reference cross-section along a length direction of the ear hook and in a natural state of the earphone, the elastic metal member includes an elastic segment. The elastic segment is divided into a first sub-elastic segment and a second sub-elastic segment that are arranged in an arc shape and connected to each other, the first sub-elastic segment is connected to the sound-generating portion, and the second sub-elastic segment is connected to the abutment portion. In a direction away from a connection point of the first sub-elastic segment and the second sub-elastic segment, a curvature radius of at least a portion of the first sub-elastic segment starting from the connection point and a curvature radius of at least a portion of the second sub-elastic segment starting from the connection point gradually increase. A length of the first sub-elastic segment is greater than a length of the second sub-elastic segment. The first sub-elastic segment has a first curvature radius at a first endpoint of the first sub-elastic segment away from the connection point, the second sub-elastic segment has a second curvature radius at a second endpoint of the second sub-elastic segment away from the connection point, and the first curvature radius is greater than the second curvature radius.

In some embodiments, a length of a first connecting line between the connection point and the first endpoint is in a range of 10 mm to 18 mm, the first sub-elastic segment is located at an outer side of the first connecting line, and a length of a second connecting line between the connection point and the second endpoint is in a range of 2 mm to 9 mm, and the second sub-elastic segment is located at an outer side of the second connecting line.

In some embodiments, an arc-to-chord ratio of the first sub-elastic segment is in a range of 1.01 to 1.1, and an arc-to-chord ratio of the second sub-elastic segment is in a range of 1.01 to 1.12.

In some embodiments, at the connection point, the ear hook has a third curvature radius in a range of 4 mm to 7 mm, a difference between the first curvature radius and the third curvature radius is in a range of 10 mm to 25 mm, and a difference between the second curvature radius and the third curvature radius is in a range of 1 mm to 5 mm.

In some embodiments, in a direction away from the connection point and between the connection point and the first endpoint, a curvature radius of the first sub-elastic segment gradually increases, and in the direction away from the connection point and between the connection point and the second endpoint, a curvature radius of the second sub-elastic segment gradually increases.

In some embodiments, the first sub-elastic segment has a first tangential direction at the first endpoint, the second sub-elastic segment has a second tangential direction at the second endpoint, and an angle between the first tangential direction and the second tangential direction is in a range of 43° to 100°.

In some embodiments, the ear hook has a normal direction at the connection point, an angle between the first tangential direction and the normal direction is in a range of 15° to 41°, and an angle between the second tangential direction and the normal direction is in a range of 24° to 80°.

In some embodiments, an outer wall surface of the sound-generating portion and an outer wall surface of the abutment portion abut against each other, an arc formed in the reference cross-section by an abutment region of the outer wall surface of the sound-generating portion and the outer wall surface of the abutment portion has a midpoint, and an angle between a connecting line of the midpoint of the arc and the connection point and the normal direction is in a range of 0° to 8°.

In some embodiments, the ear hook includes a bistable structure disposed on the elastic segment and configured to enable the ear hook to have a first stable position and a second stable position, and a minimum distance between the sound-generating portion and the abutment portion when the ear hook is in the first stable position is greater than a minimum distance between the sound-generating portion and the abutment portion when the ear hook is in the second stable position.

In some embodiments, the bistable structure includes a protruding portion and an abutment member that are connected to the elastic segment at intervals, the abutment member abuts against a protrusion point of the protruding portion, and the first stable position and the second stable position are formed when the abutment member abuts against two sides of the protrusion point, respectively.

In some embodiments, in the natural state of the earphone, the sound-generating portion and the abutment portion abut against each other under an action of the ear hook.

In some embodiments, the reference cross-section is a symmetry plane of the ear hook.

In some embodiments, the elastic metal member is an elastic metal wire, and the symmetry plane of the ear hook is a plane in which a central axis of the elastic metal wire lies.

In some embodiments, the elastic metal member is an elastic metal sheet, two opposite ends of the elastic metal sheet along a length direction of the elastic metal sheet are connected to the sound-generating portion and the abutment portion, respectively, and in the wearing state of the earphone, a thickness direction of the elastic metal sheet faces towards or away from the helix, and the symmetry plane of the ear hook bisects the elastic metal sheet along a width direction of the elastic metal sheet.

In some embodiments, a width-to-thickness ratio of the elastic metal sheet between the first endpoint and the second endpoint is in a range of 8 to 20.

The beneficial effects of the present disclosure are as follows. Through the above configuration, the elastic segment better matches physiological structures of the helix and the cavum conchae, thereby effectively improving the clamping effect of the elastic segment and further effectively improving the wearing stability of the earphone. In addition, the first endpoint is an endpoint where the first sub-elastic segment is connected to the sound-generating portion, and the second endpoint is an endpoint where the second sub-elastic segment is connected to the abutment portion. Since a contour at a connection between the helix and the cavum conchae has a mutation point, the first curvature radius is set at the first endpoint, and the second curvature radius is set at the second endpoint, so that the elastic segment better matches the physiological structures of the helix and the cavum conchae, thereby effectively improving the clamping effect of the elastic segment and further effectively improving the wearing stability of the earphone.

It should be understood that the foregoing general description and the following detailed description are exemplary and explanatory only and are not restrictive of the present disclosure.

### BRIEF DESCRIPTION OF THE DRAWINGS

In order to more clearly illustrate the technical solutions in the embodiments of the present disclosure, the drawings used in the description of the embodiments will be briefly introduced below. It is apparent that the drawings in the following description are only some embodiments of the present disclosure. For those skilled in the art, other drawings may be obtained from these drawings without creative effort.

FIG. 1 is a schematic diagram illustrating a front view of an earphone of the present disclosure after being worn on an ear of a user with large ears or small ears.

FIG. 2 is a schematic diagram illustrating a three-dimensional structure of the earphone shown in FIG. 1.

FIG. 3 is a schematic diagram illustrating a cross-section a-a of the earphone shown in FIG. 1 after being worn on the ear of the user with large ears.

FIG. 4 is a schematic diagram illustrating a cross-section a-a of the earphone shown in FIG. 1 after being worn on the ear of the user with small ears.

FIG. 5 is a schematic diagram illustrating a reference cross-section b-b of the earphone shown in FIG. 2 in a natural state where an abutment portion and a sound-generating portion do not abut against each other.

FIG. 6 is a schematic diagram illustrating a structure of a reference cross-section b-b of the earphone shown in FIG. 2 in a natural state where an abutment portion and a sound-generating portion abut against each other.

FIG. 7 is another schematic diagram illustrating a reference cross-section b-b of the earphone shown in FIG. 2 in a natural state where an abutment portion and a sound-generating portion do not abut against each other.

FIG. 8 is another schematic diagram illustrating a reference cross-section b-b of the earphone shown in FIG. 2 in a natural state where an abutment portion and a sound-generating portion do not abut against each other.

FIG. 9 is another schematic diagram illustrating a reference cross-section b-b of the earphone shown in FIG. 2 in a natural state where an abutment portion and a sound-generating portion do not abut against each other.

FIG. 10 is another schematic diagram illustrating a reference cross-section b-b of the earphone shown in FIG. 2 in a natural state where an abutment portion and a sound-generating portion do not abut against each other.

FIG. 11 is another schematic diagram illustrating a reference cross-section b-b of the earphone shown in FIG. 2 in a natural state where an abutment portion and a sound-generating portion do not abut against each other.

FIG. 12 is another schematic diagram illustrating a reference cross-section b-b of the earphone shown in FIG. 2 in a natural state where an abutment portion and a sound-generating portion do not abut against each other.

FIG. 13 is another schematic diagram illustrating a reference cross-section b-b of the earphone shown in FIG. 2 in a natural state where an abutment portion and a sound-generating portion do not abut against each other.

FIG. 14 is a schematic diagram illustrating a structure of the earphone shown in FIG. 1, highlighting an elastic metal sheet.

### DETAILED DESCRIPTION

The following describes the present disclosure in further detail with reference to the accompanying drawings and embodiments. It is specifically pointed out that the following embodiments are only used to illustrate the present disclosure but do not limit the scope of the present disclosure. Similarly, the following embodiments are only some embodiments of the present disclosure rather than all embodiments. All other embodiments obtained by those skilled in the art without creative efforts shall fall within the protection scope of the present disclosure.

The term “embodiment” as used in the present disclosure indicates that a specific feature, structure, or characteristic described in combination with the embodiment may be included in at least one embodiment of the present disclosure. Those skilled in the art explicitly and implicitly understands that the embodiments described in the present disclosure may be combined with other embodiments.

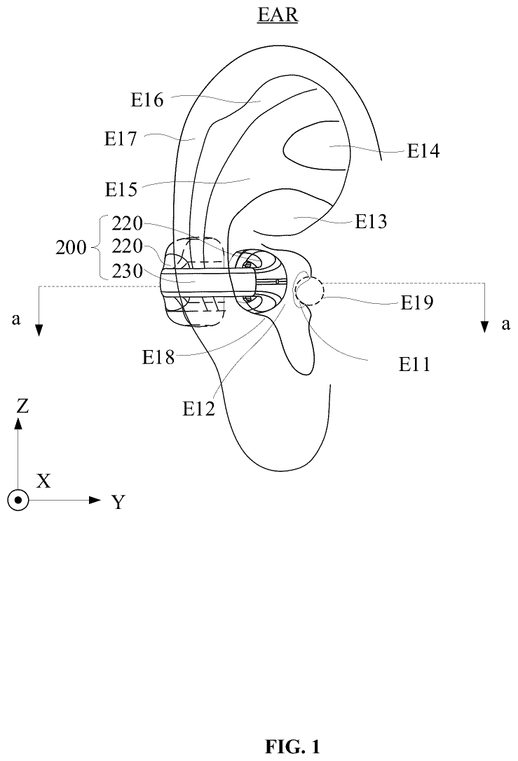

With reference to FIG. 1, an ear EAR of a user includes physiological portions such as an ear canal E11, a cavum conchae E12, a cymba conchae E13, a triangular fossa E14, an antihelix E15, a scapha E16, a helix E17, and an antitragus E18. Although the ear canal E11 has a certain depth and extends to a tympanic membrane of the ear, for ease of description and with reference to FIG. 1, in the present disclosure, unless otherwise specified, the ear canal E11 specifically refers to an entrance (i.e., an ear orifice) thereof facing away from the tympanic membrane. Further, physiological portions such as the cavum conchae E12, the cymba conchae E13, and the triangular fossa E14 have a certain volume and depth. The cavum conchae E12 is in direct communication with the ear canal E11. That is, the ear orifice may be simply considered to be located at a bottom of the cavum conchae E12.

The ear EAR further includes a tragus E19 outside around the ear canal. Compared with portions such as the cavum conchae E12, the cymba conchae E13, and the triangular fossa E14 that have a certain depth and volume in a three-dimensional space (that is, these portions are recessed towards a rear side of the ear along a direction towards the head of the user), the tragus E19 protrudes towards a front side of the ear along a direction away from the head of the user. “The front side of the ear” is a concept relative to “the rear side of the ear”. The former refers to a side of the ear away from the head, as shown in FIG. 1. The latter refers to a side of the ear towards the head. Both the former and the latter are for the ear of the user.

Different users may have individual differences, resulting in differences in shape, size, and other dimensions of ears. For ease of description and to reduce (or even eliminate) individual differences of different users, unless otherwise specified, the present disclosure mainly uses an ear model with a “standard” shape and size as a reference to further describe wearing manners of an acoustic device on the ear model in different embodiments. For example, a simulator including a head and (left and right) ears of the head may be manufactured based on ANSI: S3.36, S3.25 and IEC: 60318-7 standards, for example, GRAS 45BC KEMAR serves as a reference for wearing the acoustic device to present a scenario in which most users normally wear the acoustic device. Merely by way of example, the ear used as a reference may have the following related features including a size of a projection of a helix on a sagittal plane in a direction of a vertical axis being in a range of 49.5 mm to 74.3 mm, and a size of the projection of the helix on the sagittal plane in a direction of a sagittal axis being in a range of 36.6 mm to 55 mm. Therefore, in the present disclosure, terms such as “worn by a wearer or a user”, “in a wearing state”, and “under the wearing state” refer to that the acoustic device described in the present disclosure is worn on the ear of the foregoing simulator. Certainly, considering that different users have individual differences, structures, shapes, sizes, thicknesses, etc., of one or more portions in the ear EAR may have certain differences. To satisfy needs of the different users, the acoustic device may be differentially designed. The differential design may be reflected in that characteristic parameters of one or more structures (e.g., a sound-generating portion 210, an ear hook 230, or the like described below) in the acoustic device may be in different ranges to adapt to different ears.

It should be noted that, in fields such as medicine and anatomy, three basic planes of a human body, including a sagittal plane, a coronal plane, and a horizontal plane, and three basic axes of the human body, including a sagittal axis, a coronal axis, and a vertical axis, may be defined. The sagittal plane refers to a plane made along an anteroposterior direction of the body and perpendicular to the ground, which divides the human body into left and right portions. The coronal plane refers to a plane made along a left-right direction of the body and perpendicular to the ground, which divides the human body into front and rear portions. The horizontal plane refers to a plane made along a vertical direction of the body and parallel to the ground, which divides the human body into upper and lower portions. Correspondingly, the sagittal axis refers to an axis along the anteroposterior direction of the body and perpendicular to the coronal plane. The coronal axis refers to an axis along the left-right direction of the body and perpendicular to the sagittal plane. The vertical axis refers to an axis along the vertical direction of the body and perpendicular to the horizontal plane. Further, “the front side of the ear” described in the present disclosure is the concept relative to “the rear side of the ear”. The former refers to the side of the ear away from the head, and the latter refers to the side of the ear facing the head. Both the former and the latter are for the ear of the user. When the ear of the foregoing simulator is observed along a direction of the coronal axis of the human body, a schematic diagram of a front side contour of the ear shown in FIG. 1 may be obtained. Based on this, with reference to FIG. 1, three directions X, Y, and Z may be simply considered as the coronal axis, the sagittal axis, and the vertical axis of the human body, respectively. Three planes XY, XZ, and YZ may be simply considered as the horizontal plane, the coronal plane, and the sagittal plane of the human body, respectively.

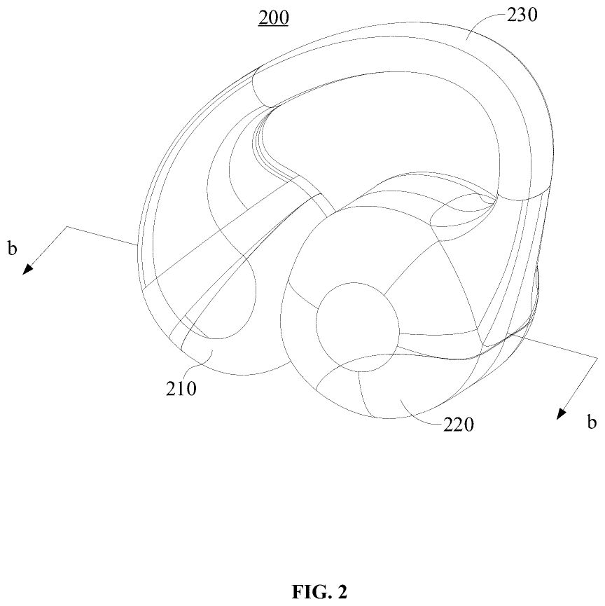

With reference to FIGS. 2-4, the present disclosure provides an earphone 200. The earphone 200 is an ear-clip earphone. The earphone 200 includes the sound-generating portion 210 inserted into the cavum conchae E12 of the wearer, an abutment portion 220 for abutting against the rear side of the ear of the wearer, and the ear hook 230 connected to the sound-generating portion 210 and the abutment portion 220. The sound-generating portion 210 refers to a sound playback device. The sound-generating portion 210 is configured to convert an electrical signal into a sound signal and play the sound signal to the wearer. In the wearing state, the sound-generating portion 210 is located in the cavum conchae E12. In some embodiments, the abutment portion 220 and the sound-generating portion 210 form a clamping state, so that the entire earphone 200 is clamped and worn on the helix E17 of a user. In some embodiments, the abutment portion 220 may be used as a battery compartment to accommodate a battery or other components. Certainly, the abutment portion 220 may not be used as the battery compartment, and the battery may be installed in the sound-generating portion 210. The ear hook 230 refers to a component that provides a clamping force. Two ends of the ear hook 230 are connected to the sound-generating portion 210 and the abutment portion 220, respectively. In the wearing state, the ear hook 230 bypasses the helix E17, so that the sound-generating portion 210 and the abutment portion 220 are located on two sides of the ear of the human body along the coronal axis, and the sound-generating portion 210 extends into the cavum conchae E12 to transmit sound to the ear canal.

With reference to FIGS. 2-6, the earphone 200 includes a reference cross-section b-b. The reference cross-section b-b is provided along a length direction of the ear hook 230. In the wearing state, the reference cross-section b-b is nearly parallel to the horizontal plane of the human body. In the reference cross-section b-b, the ear hook 230, the sound-generating portion 210, and the abutment portion 220 define an inner contour 300. The inner contour 300 includes at least a reference point C, a reference point E, a reference point H, and a reference point L. The earphone 200 further includes a reference point O.

The reference point C refers to a reference point on the inner contour 300 that has a special positional relationship with the helix E17. In some embodiments, in the wearing state, the reference point C is located on the ear hook 230 and corresponds to an edge 1071 of the helix E17, and the reference point C is an inflection point of the inner contour 300. For example, the inner contour 300 is a contour line that protrudes away from the helix E17 as a whole. A curvature radius of at least a portion of the inner contour 300 located at the edge 1071 is configured to first gradually increase, then gradually decrease, and then gradually increase again from the reference point C towards both the sound-generating portion 210 and the abutment portion 220.

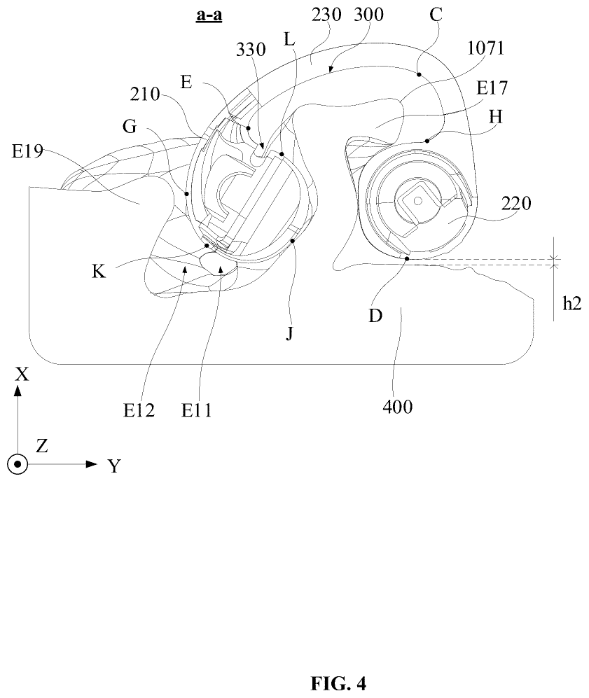

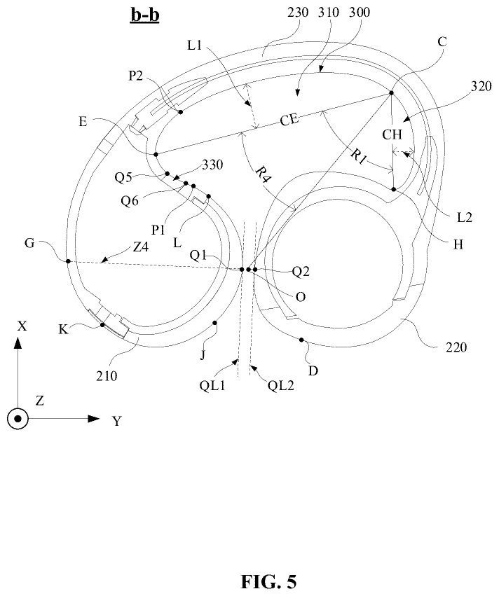

With reference to FIG. 5, the reference point O refers to a reference point that indicates a special positional relationship between the sound-generating portion 210 and the abutment portion 220. In the natural state, a midpoint of a shortest connecting line Q1Q2 between an outer wall surface of the sound-generating portion 210 and an outer wall surface of the abutment portion 220 serves as the reference point O. As shown in FIG. 4, in some embodiments, in the natural state, the outer wall surface of the sound-generating portion 210 and the outer wall surface of the abutment portion 220 do not abut against each other. A reference point Q1 on the outer wall surface of the sound-generating portion 210 has a tangent line QL1. The tangent line QL1 is a line passing through the reference point Q1 and tangent to the outer wall surface of the sound-generating portion 210. A reference point Q2 on the outer wall surface of the abutment portion 220 has a tangent line QL2. The tangent line QL2 is a line passing through the reference point Q2 and tangent to the outer wall surface of the abutment portion 220. The tangent line QL1 and the tangent line QL2 are parallel to each other. The shortest connecting line Q1Q2 is a normal line of the outer wall surface of the sound-generating portion 210 at the reference point Q1, and is a normal line of the outer wall surface of the abutment portion 220 at the reference point Q2, and is a connecting line when the distance between the tangent line QL1 and the tangent line QL2 is the shortest.

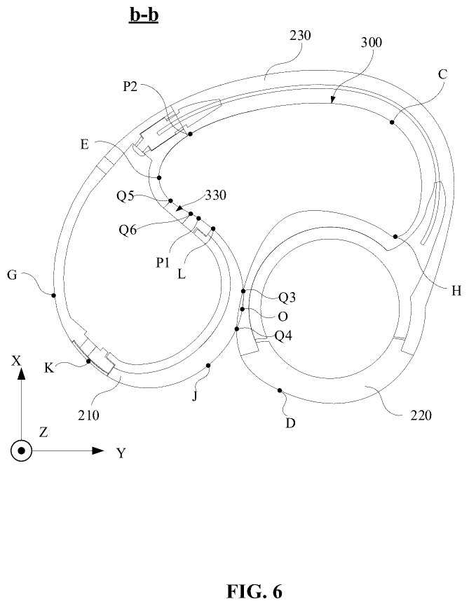

In some embodiments, further with reference to FIG. 6, if the outer wall surface of the sound-generating portion 210 and the outer wall surface of the abutment portion 220 abut against each other in the natural state, the length of the shortest connecting line between the outer wall surface of the sound-generating portion 210 and the outer wall surface of the abutment portion 220 is nearly 0. At this time, the reference point O may be a midpoint of an arc line Q3Q4 formed by an abutment region between the outer wall surface of the sound-generating portion 210 and the outer wall surface of the abutment portion 220. The reference point E refers to a reference point on the sound-generating portion 210 that faces the reference point C. The reference point H refers to a reference point on the abutment portion 220 that faces the reference point C. The reference point L refers to a reference point on the sound-generating portion 210 that is closest to the reference point C.

Therefore, further with reference to FIGS. 5-6, in some embodiments, the reference point C may be directly positioned through a positional relationship between the reference point C and the edge 1071 of the helix E17, to use the reference point C as a first reference point. In some embodiments, the reference point E, the reference point H, the reference point L, and the reference point O are defined by the reference point C, and the reference point E, the reference point H, the reference point L, and the reference point O are used as a second reference point, a third reference point, a fourth reference point, and a fifth reference point, respectively, so as to define an overall structure of the earphone 200. Based on this, the overall structure of the earphone 200 can better match the physiological structures of the helix E17 and the cavum conchae E12, thereby effectively improving the wearing comfort of the earphone 200.

In some embodiments, in some embodiments, the reference point C is also a reference point indicating a special positional relationship between the reference point O and the inner contour 300. That is, the reference point C is a reference point on the inner contour 300 that is farthest from the reference point O. Therefore, the reference point C may be positioned by the reference point O. That is, the reference point O is used as the first reference point. Then, the reference point C is determined by the special positional relationship between the reference point O and the inner contour 300, and the reference point C is used as the second reference point. Further, the reference point E, the reference point H, and the reference point L are defined by the reference point O and the reference point C, and are used as the third reference point, the fourth reference point, and the fifth reference point, respectively, to define the overall structure of the earphone 200. Based on this, the overall structure of the earphone 200 can better match the physiological structures of the helix E17 and the cavum conchae E12, thereby effectively improving the wearing comfort of the earphone 200.

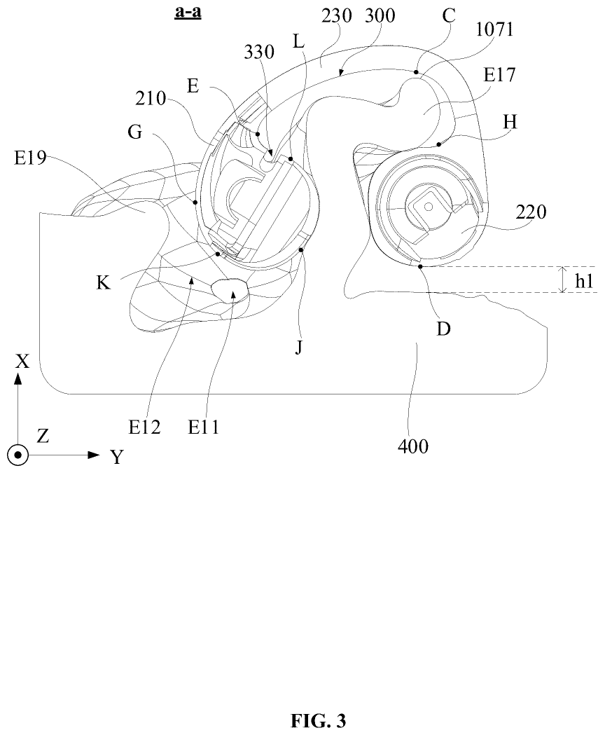

In some embodiments, with reference to FIGS. 3-5, in some embodiments, a connecting line CE is formed between the reference point C and the reference point E, and a connecting line CH is formed between the reference point C and the reference point H. In the natural state, a length of the connecting line CE is in a range of 16 mm to 19 mm, and may be 17 mm or 18 mm. A length of the connecting line CH is in a range of 6.5 mm to 9.0 mm, and may be 6.8 mm, 7.3 mm, 7.8 mm, 8.1 mm, 8.5 mm, or 8.8 mm. An angle R1 between the connecting line CE and the connecting line CH is in a range of 72° to 88°, and may be 75°, 78°, 81°, or 85°. A portion of the inner contour 300 between the reference point C and the reference point E is located at an outer side 310 of the connecting line CE. A portion of the inner contour 300 between the reference point C and the reference point H is located at an outer side 320 of the connecting line CH. For example, in some embodiments, the length of the connecting line CE may also be in a range of 16 mm to 18.4 mm or in a range of 16.5 mm to 18 mm, which falls within the range of 16 mm to 19 mm. The length of the connecting line CH may also be in a range of 6.6 mm to 8.6 mm or in a range of 6.8 mm to 8 mm, which falls within the range of 6.5 mm to 9.0 mm.

In some embodiments, the reference point E refers to a reference point at a side of the reference point C towards the sound-generating portion 210. The reference point E and the reference point C form the connecting line CE. The inner contour 300 between the reference point C and the reference point E is located at the outer side 310 of the connecting line CE. The reference point H is a reference point at a side of the reference point C towards the abutment portion 220. The reference point H and the reference point C form the connecting line CH. The inner contour 300 between the reference point C and the reference point H is located at the outer side 320 of the connecting line CH. When wearing the ear-clip earphone 200, if the inner contour 300 of the earphone 200 contacts the helix E17, the wearing comfort of the earphone 200 is greatly affected during long-term use, thereby affecting the use experience of the wearer. In some embodiments, the connecting line CE is also referred to as a first connecting line or a second connecting line, and the connecting line CH is also referred to as the second connecting line or a third connecting line.

If the angle R1 between the connecting line CE and the connecting line CH is too small, the inner contour 300 of the earphone 200, especially the portion of the inner contour 300 between the reference point C and the reference point E and the portion of the inner contour 300 between the reference point C and the reference point H, are unable to bypass the helix E17 as much as possible. If the angle R1 is too large, the overall volume of the earphone 200 is increased, so that the overall mass of the earphone 200 is relatively large, resulting in unstable wearing of the earphone 200. Therefore, the angle R1 between the connecting line CE and the connecting line CH is set in a range of 72° to 88°, so that the inner contour 300 of the earphone 200 may bypass the helix E17 as much as possible, which can reduce contact between the inner contour 300 of the earphone 200 and the helix E17, and effectively reduce the overall volume of the earphone 200, thereby effectively improving the wearing comfort and wearing stability of the earphone 200. For example, in some embodiments, the angle R1 between the connecting line CE and the connecting line CH may be set to 80°.

Furthermore, if the length of the connecting line CE is too small, the sound-generating portion 210 may not extend into the cavum conchae E12, the sound quality of the earphone 200 is affected, or after the sound-generating portion 210 extends into the cavum conchae E12, the inner contour 300 of the earphone 200, especially the position of the reference point C, may contact the helix E17. Conversely, if the length of the connecting line CE is too large, the overall structural volume of the earphone 200 is increased, resulting in a larger overall mass and unstable wearing of the earphone 200. Therefore, the length of the connecting line CE is set in a range of 16 to 19 mm or in a range of 16 to 18.4 mm, so that the sound-generating portion 210 stably extends into the cavum conchae E12, which prevents the inner contour 300 and the sound-generating portion 210 from contacting the helix E17, and effectively reduces the overall volume of the earphone 200, thereby improving the wearing comfort and sound transmission quality of the earphone 200 while effectively enhancing the wearing stability of the earphone 200. Furthermore, if the length of the connecting line CH is too small, the abutment portion 220 may contact the helix E17. If the length of the connecting line CH is too large, the overall volume of the earphone 200 is increased, resulting in a larger overall mass and unstable wearing of the earphone 200. Therefore, the length of the connecting line CH is set in a range of 6.5 to 9.0 mm or 6.6 to 8.6 mm, so that the inner contour 300 of the earphone 200 may bypass the helix E17 as much as possible, to prevent the inner contour 300 and the abutment portion 220 from contacting the helix E17, which can effectively reduce the overall volume of the earphone 200, thereby effectively improving the wearing comfort and wearing stability of the earphone 200. For example, in some embodiments, the length of the connecting line CE is set to 17.13 mm, and the length of the connecting line CH is set to 7.59 mm.

In some embodiments, further referring to FIGS. 3-4, in some embodiments, a curved shape of the inner contour 300 matches the physiological structures of the helix E17 and the cavum conchae E12. Based on this, the inner contour 300 may bypass the helix E17 as much as possible without contacting the helix E17 while also effectively reducing the overall volume of the earphone 200.

For example, in some embodiments, a curvature radius of the inner contour 300 is configured to first gradually increase, then gradually decrease, and then gradually increase again from the reference point C towards both the sound-generating portion 210 and the abutment portion 220, the reference point E is a minimum point of the curvature radius from the reference point C towards the sound-generating portion 210, and the reference point H is a minimum point of the curvature radius from the reference point C towards the abutment portion 220. In some embodiments, the curvature radius first gradually increases, then gradually decreases, and then gradually increases again from the reference point C towards both the sound-generating portion 210 and the abutment portion 220. Based on this, the inner contour 300 better matches the physiological structures of the helix E17 and the cavum conchae E12, thereby effectively reducing the overall volume of the earphone 200 to improve the wearing stability of the earphone 200. Furthermore, when the earphone 200 is in the wearing state, it can effectively prevent the inner contour 300 from contacting the helix E17, thereby effectively improving the wearing comfort of the earphone 200. The reference point E and the reference point H are a reference point on the sound-generating portion 210 that faces the reference point C and a reference point on the abutment portion 220 that faces the reference point C, respectively. The reference point E is a minimum point of the curvature radius from the reference point C towards the sound-generating portion 210, and the reference point H is a minimum point of the curvature radius from the reference point C towards the abutment portion 220. Furthermore, the reference point E is a first minimum point of the curvature radius appearing after the inner contour 300 extends from the reference point C towards the sound-generating portion 210, and the reference point H is a first minimum point of the curvature radius appearing after the inner contour 300 extends from the reference point C towards the abutment portion 220. Based on this, after the sound-generating portion 210 and the abutment portion 220 bypass the helix E17, respectively, along the sagittal axis of the human body, the sound-generating portion 210 and the abutment portion 220 can sufficiently abut against two sides of the cavum conchae, thereby effectively improving the wearing stability of the earphone 200.

As another example, in some embodiments, a straight-line distance between the reference point C and other points on the inner contour 300 first gradually increases and then gradually decreases from the reference point C towards both the sound-generating portion 210 and the abutment portion 220, the reference point E is a maximum point of the straight-line distance from the reference point C towards the sound-generating portion 210, and the reference point H is a maximum point of the straight-line distance from the reference point C towards the abutment portion 220. In some embodiments, the straight-line distance between other points on the inner contour 300 and the reference point C first gradually increases and then gradually decreases from the reference point C towards both the sound-generating portion 210 and the abutment portion 220. Based on this, the inner contour 300 better matches the physiological structures of the helix E17 and the cavum conchae E12, thereby effectively reducing the overall volume of the earphone 200 to improve the wearing stability of the earphone 200. Furthermore, when the earphone 200 is in the wearing state, it can effectively prevent the inner contour 300 from contacting the helix E17, thereby effectively improving the wearing comfort of the earphone 200. The reference point E is a maximum point of the straight-line distance from the reference point C towards the sound-generating portion 210, and the reference point H is a maximum point of the straight-line distance from the reference point C towards the abutment portion 220. Furthermore, the reference point E is a first maximum point of the straight-line distance appearing after the inner contour 300 extends from the reference point C towards the sound-generating portion 210, and the reference point H is a first maximum point of the straight-line distance appearing after the inner contour 300 extends from the reference point C towards the abutment portion 220. Based on this, after the sound-generating portion 210 and the abutment portion 220 bypass the helix E17, respectively, along the sagittal axis of the human body, the sound-generating portion 210 and the abutment portion 220 can sufficiently abut against the two sides of the cavum conchae, thereby effectively improving the wearing stability of the earphone 200.

In some embodiments, referring to FIG. 5, in some embodiments, an arc-to-chord ratio of the portion of the inner contour 300 between the reference point C and the reference point E is in a range of 1.02 to 1.20, e.g., 1.05, 1.08, 1.12, 1.16, or 1.18. In some embodiments, the arc-to-chord ratio of the portion of the inner contour 300 between the reference point C and the reference point E may also be in a range of 1.02 to 1.16, or in a range of 1.02 to 1.1, or other value ranges falling within the range of 1.02 to 1.20.

In some embodiments, the arc-to-chord ratio of the portion of the inner contour 300 between the reference point C and the reference point E refers to a ratio of an actual length of the portion of the inner contour 300 between the reference point C and the reference point E to the length of the connecting line CE. In some embodiments, the inner contour 300 is a curved arc-shaped contour, and the arc-to-chord ratio of the portion of the inner contour 300 between the reference point C and the reference point E is a ratio of an arc length of the portion of the inner contour 300 between the reference point C and the reference point E to the length of the connecting line CE. It is worth noting that, in this embodiment, the portion of the inner contour 300 between the reference point C and the reference point E is a continuous arc protruding away from the connecting line CE. In other embodiments, the inner contour 300 may not be set as a curve, the inner contour 300 may also be a plurality of straight line segments, etc.

If the arc-to-chord ratio of the portion of the inner contour 300 between the reference point C and the reference point E is too small, the portion of the inner contour 300 between the reference point C and the reference point E becomes relatively straight, which is not conducive to the portion of the inner contour 300 between the reference point C and the reference point E bypassing the helix E17. If the arc-to-chord ratio of the portion of the inner contour 300 between the reference point C and the reference point E is too large, resulting in the portion of the inner contour 300 between the reference point C and the reference point E being overly curved, the overall volume of the earphone 200 is increased. Therefore, the arc-to-chord ratio of the portion of the inner contour 300 between the reference point C and the reference point E is set in a range of 1.02 to 1.20 or in a range of 1.02 to 1.16, enabling the portion of the inner contour 300 between the reference point C and the reference point E to bypass the helix E17 as much as possible without contacting the helix E17, thereby effectively improving the wearing comfort of the earphone 200 while also effectively enhancing the wearing stability of the earphone 200. For example, the arc-to-chord ratio between the reference point C and the reference point E may be set to 1.1.

In some embodiments, referring to FIG. 5, along a perpendicular line to the connecting line CE, a first maximum distance L1 exists between the connecting line CE and the inner contour 300. The first maximum distance L1 is in a range of 2.1 to 3.7 mm, e.g., 2.3 mm, 2.6 mm, 2.9 mm, 3.2 mm, or 3.6 mm. Furthermore, a ratio of a first distance and the length of the first connecting line is in a range of 0.2 to 0.55, e.g., 0.3, 0.4, or 0.52. The first distance is a distance between a first intersection point and the reference point C, and the first intersection point is an intersection point of the perpendicular line corresponding to the first maximum distance L1 with the connecting line CE.

In some embodiments, a distance between the connecting line CE and the inner contour 300 in a reference plane refers to a perpendicular line segment to the connecting line CE that intersects both the connecting line CE and the inner contour 300. A maximum distance between the connecting line CE and the portion of the inner contour 300 between the reference point C and the reference point E is the first maximum distance L1. The first maximum distance L1 may not be too short or too long. If the first maximum distance L1 is too short, the arc-to-chord ratio of the portion of the inner contour 300 between the reference point C and the reference point E is reduced, so that the portion of the inner contour 300 between the reference point C and the reference point E may not sufficiently bypass the helix E17, and the wearing comfort of the earphone 200 is affected. If the first maximum distance L1 is too long, the arc-to-chord ratio of the portion of the inner contour 300 between the reference point C and the reference point E is increased, resulting in the portion of the inner contour 300 between the reference point C and the reference point E being overly curved, and the overall volume of the earphone 200 being increased. Therefore, the first maximum distance L1 is set in a range of 2.1 to 3.7 mm, to effectively prevent the portion of the inner contour 300 between the reference point C and the reference point E from contacting the helix E17, thereby effectively improving the wearing comfort of the earphone 200 while also effectively enhancing the wearing stability of the earphone 200.

Furthermore, the ratio of the first distance and the length of the first connecting line is in a range of 0.2 to 0.55, resulting in a relatively reasonable positional relationship between the first maximum distance L1 (between the inner contour 300 and the connecting line CE) and the connecting line CE itself. This ensures that the portion of the inner contour 300 between the reference point C and the reference point E does not contact the helix E17, thereby improving the wearing comfort of the earphone 200 and also effectively enhancing the wearing stability of the earphone 200.

For example, the first maximum distance L1 is 2.88 mm, and the ratio of the first distance and the length of the first connecting line is approximately 0.45.

In some embodiments, an arc-to-chord ratio of the portion of the inner contour 300 between the reference point C and the reference point H is in a range of 1.05 to 1.23, e.g., 1.07, 1.1, or 1.15. In some embodiments, the arc-to-chord ratio of the portion of the inner contour 300 between the reference point C and the reference point H may also be in a range of 1.10 to 1.23, etc.

In some embodiments, the arc-to-chord ratio of the portion of the inner contour 300 between the reference point C and the reference point H refers to a ratio of an actual length of the portion of the inner contour 300 between the reference point C and the reference point H to the length of the connecting line CH. Merely by way of example, the inner contour 300 is a curved arc-shaped contour, and the arc-to-chord ratio of the portion of the inner contour 300 between the reference point C and the reference point H is a ratio of an arc length of the portion of the inner contour 300 between the reference point C and the reference point H to the length of the connecting line CH. It is worth noting that, in this embodiment, the portion of the inner contour 300 between the reference point C and the reference point H is a continuous arc protruding away from the connecting line CH. In other embodiments, the inner contour 300 may not be set as a curve, but be a plurality of straight line segments, etc.

If the arc-to-chord ratio of the portion of the inner contour 300 between the reference point C and the reference point H is too small, the portion of the inner contour 300 between the reference point C and the reference point H becomes relatively straight, which is not conducive to the portion of the inner contour 300 between the reference point C and the reference point H bypassing the helix E17. If the arc-to-chord ratio of the portion of the inner contour 300 between the reference point C and the reference point H is too large, resulting in the inner contour 300 between the reference point C and the reference point H being overly curved, and the overall volume of the earphone 200 being increased. Therefore, the arc-to-chord ratio of the portion of the inner contour 300 between the reference point C and the reference point H is set in a range of 1.10 to 1.23, to enable the inner contour 300 between the reference point C and the reference point H to bypass the helix E17 as much as possible without contacting the helix E17, thereby effectively improving the wearing comfort of the earphone 200 while also effectively enhancing the wearing stability of the earphone 200. Moreover, the arc-to-chord ratio of the portion of the inner contour 300 between the reference point C and the reference point H is set in a range of 1.10 to 1.23, to enable the inner contour 300 to conform to the contours of the ears of most populations, thereby effectively improving the applicability of the earphone 200. In some embodiments, the arc-to-chord ratio of the portion of the inner contour 300 between the reference point C and the reference point E is set to 1.19.

In some embodiments, referring to FIG. 5, along a perpendicular line to the connecting line CH, a second maximum distance L2 exists between the second connecting line and the inner contour 300. The second maximum distance L2 is in a range of 1.05 to 2.0 mm, e.g., 1.08 mm, 1.12 mm, 1.3 mm, 1.34 mm, 1.48 mm, 1.72 mm, 1.86 mm, or 1.91 mm. A ratio of a second distance and the length of the connecting line CH is in a range of 0.4 to 0.8, e.g., 0.43, 0.49, 0.56, 0.63, 0.66, 0.71, or 0.77. The second distance is a distance between a second intersection point and the reference point C, and the second intersection point is an intersection point of the perpendicular line corresponding to the second maximum distance L2 with the second connecting line. In some embodiments, the second maximum distance L2 may be in a range of 1.5 to 2.0 mm or in a range of 1.05 to 1.18 mm, or other value ranges within the range of 1.05 to 2.0 mm. The ratio of the second distance and the length of the connecting line CH is in a range of 0.41 to 0.61, or other value ranges located within the range of 0.4 to 0.8.

In some embodiments, a distance between the connecting line CH and the inner contour 300 in the reference plane refers to a perpendicular line segment to the connecting line CH that intersects both the connecting line CH and the inner contour 300. The maximum distance between the connecting line CH and the portion of the inner contour 300 between the reference point C and the reference point H is the second maximum distance L2. The second maximum distance L2 may not be too short or too long. If the second maximum distance L2 is too short, the arc-to-chord ratio of the portion of the inner contour 300 between the reference point C and the reference point H is reduced, so than the portion of the inner contour 300 between the reference point C and the reference point H may not sufficiently bypass the helix E17, and the wearing comfort of the earphone 200 is affected. If the second maximum distance L2 is too long, the arc-to-chord ratio of the portion of the inner contour 300 between the reference point C and the reference point H is increased, resulting in the portion of the inner contour 300 between the reference point C and the reference point H being overly curved and easily squeezing the helix E17, and the wearing comfort of the earphone 200 being affected. Therefore, the second maximum distance L2 is set in a range of 1.5 to 2.0 mm or in a range of 1.05 to 1.18 mm, to effectively prevent the portion of the inner contour 300 between the reference point C and the reference point H from contacting the helix E17 and prevent the earphone 200 from squeezing the helix E17, thereby effectively improving the wearing comfort of the earphone 200.

Furthermore, the ratio of the second distance and the length of the connecting line CH is set in a range of 0.4 to 0.8 or in a range of 0.41 to 0.61, resulting in a relatively reasonable positional relationship between the first maximum distance L2 (between the inner contour 300 and the connecting line CH) and the connecting line CH. This ensures that the portion of the inner contour 300 between the reference point C and the reference point H does not contact the helix E17, thereby improving the wearing comfort of the earphone 200 and also effectively enhancing the wearing stability of the earphone 200. In some embodiments, the second maximum distance L2 is set to 1.8 mm, and the ratio of the second distance and the length of the connecting line CH is set to 0.51.

In some embodiments, referring to FIG. 5, in some embodiments, along the inner contour 300, an arc-to-chord ratio between two points on the inner contour that are respectively located on two sides of the reference point C and are 5 mm away from the reference point C is in a range of 1.03 to 1.12, e.g., 1.06, 1.08, or 1.1. In this embodiment, the inner contour 300 between the two points that are respectively located on two sides of the reference point C and are 5 mm away from the reference point C is a continuous arc protruding away from the sound-generating portion 210 and the abutment portion 220.

In some embodiments, when the earphone 200 is in the wearing state, the reference point C is a point on the inner contour 300 corresponding to the edge 1071 of the helix E17. A region of the inner contour 300 close to the reference point C is one of regions where the earphone 200 is prone to contact the helix E17. Therefore, if the arc-to-chord ratio of the inner contour 300 in the region is too small, the overall volume of the earphone 200 is increased, and the wearing stability of the earphone 200 is affected. If the arc-to-chord ratio of the inner contour 300 in the region is too large, the matching between the inner contour 300 and the helix E17 is affected, resulting in the earphone 200 easily contacting or squeezing the helix E17, thereby affecting the wearing comfort of the earphone 200.

For example, for most applicable populations, the inner contour 300 between the two points on the inner contour that are respectively located on the two sides of the reference point C and are 5 mm away from the reference point C is a main region where the earphone 200 is prone to contact the helix E17. Therefore, the arc-to-chord ratio between the two points on the inner contour that are respectively located on the two sides of the reference point C and are 5 mm away from the reference point C is set to a value within the aforementioned numerical range, to enable the inner contour 300 of the earphone 200 to better adapt to a contour of the helix E17 and effectively prevent the earphone 200 from contacting or squeezing the helix E17 during the wearing state, thereby effectively improving the wearing comfort of the earphone 200 while also effectively enhancing the wearing stability of the earphone 200. In some embodiments, the arc-to-chord ratio between the two points on the inner contour that are respectively located on the two sides of the reference point C and are 5 mm away from the reference point C is in a range of 1.03 to 1.12, resulting in a moderate curvature of the inner contour 300 between the two points on the inner contour that are respectively located on the two sides of the reference point C and are 5 mm away from the reference point C. In the wearing state, a more uniform distribution of deformation in the ear hook is achieved, and the likelihood of stress concentration is reduced, thereby effectively improving the stability and service life of the earphone 200.

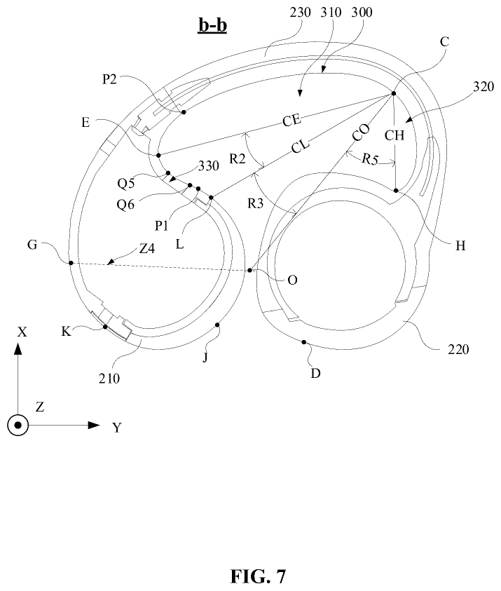

In some embodiments, referring to FIG. 7, a connecting line CL is formed between the reference point C and the reference point L. The connecting line CL is located between the connecting line CE and the connecting line CH. A length of the connecting line CL is in a range of 13 to 17 mm, e.g., 13.6 mm, 14.1 mm, 15.2 mm, 16.3 mm, or 16.6 mm. An angle R2 between the connecting line CL and the connecting line CE is in a range of 15° to 27°, e.g., 16°, 16.6°, 18.3°, 19°, 19.5°, 21°, 24°, 25.5°, 26°, or 26.8°.

In some embodiments, the connecting line CL is also referred to as a third connecting line or a fourth connecting line. A reference point L is a special point on the sound-generating portion 210 closest to the reference point C. Therefore, an angle between the connecting line CL and the connecting line CH to some extent determines whether the sound-generating portion 210 is able to be fully placed within the cavum conchae E12. The length of the connecting line CL to some extent determines whether the inner contour 300 of the earphone 200 is not in contact with the helix E17 when the sound-generating portion 210 is fully placed within the cavum conchae E12. Therefore, the length of the connecting line CL is set in a range of 13 mm to 17 mm, and the angle R2 between the connecting line CL and the connecting line CE is in a range of 15° to 27°. Based on this, the inner contour 300 does not contact or squeeze the helix E17 while allowing the sound-generating portion 210 to be fully placed within the cavum conchae E12, thereby effectively improving the wearing comfort of the earphone 200 while also effectively enhancing the sound transmission quality of the earphone 200. For example, the length of the connecting line CL is set to 15 mm, and the angle R2 between the connecting line CL and the connecting line CE is set to 21°.

In some embodiments, at least a portion of a segment between the reference point E and the reference point L is configured to be concave towards an interior of the sound-generating portion 210, and an arc-to-chord ratio of the segment is in a range of 1.02 to 1.12, e.g., 1.04, 1.07, 1.1, or 1.11. The sound-generating portion 210 is provided with a pressure relief hole 330 located within the segment. In the above descriptions, the inner contour 300 of the segment between the reference point E and the reference point L that is concave towards the interior of the sound-generating portion 210 may be a continuous arc that is concave towards the interior of the sound-generating portion 210.

In some embodiments, the segment between the reference point E and the reference point L where the pressure relief hole 330 is disposed includes: a sub-segment between the reference point E and a reference point P1, and a sub-segment between the reference point P1 and the reference point L. The sub-segment between the reference point E and the reference point P1 is concave towards the interior of the sound-generating portion 210. The sub-segment between the reference point P1 and the reference point L is convex away from the interior of the sound-generating portion 210. The pressure relief hole 330 is disposed in the segment between the reference point E and the reference point L that is concave towards the interior of the sound-generating portion 210, i.e., the pressure relief hole 330 is disposed in the sub-segment between the reference point E and the reference point P1. By disposing the pressure relief hole 330 within the sub-segment between the reference point E and the reference point P1, the pressure relief hole 330 can be effectively hidden between the earphone 200 and the ear when the earphone 200 is worn, thereby effectively improving the aesthetic appearance of the earphone 200. In some embodiments, the portion of the inner contour 300 where the pressure relief hole 330 is disposed may be a connecting line between an endpoint Q5 and an endpoint Q6 of an outer contour of the pressure relief hole 330.

Furthermore, the arc-to-chord ratio of the segment between the reference point E and the reference point L where the pressure relief hole 330 is disposed is set in a range of 1.02 to 1.12. In some embodiments, the arc-to-chord ratio of the segment is set to 1.061, to enable the sub-segment between the reference point E and the reference point P1 to form a concave arc towards the interior of the sound-generating portion 210. Based on this, the pressure relief hole 330 is effectively prevented from being blocked by the ear or the sound-generating portion 210, thereby effectively improving the pressure relief effect of the pressure relief hole 330 and consequently effectively improving the sound quality of the earphone 200.

In some embodiments, an arc-to-chord ratio between two points that are respectively located on two sides of the reference point E and are 3 mm away from the reference point E is in a range of 1.26 to 1.44.

In some embodiments, the two points that are respectively located on the two sides of the reference point E and are 3 mm away from the reference point E are the reference point P1 and a reference point P2. A portion of the inner contour 300 between the reference point P1 and the reference point P2 is an arc concave towards the interior of the sound-generating portion 210, and the arc-to-chord ratio of the portion of the inner contour 300 between the reference point P1 and the reference point P2 is in a range of 1.26 to 1.44 or in a range of 1.29 to 1.40. Based on this, the inner contour 300 between the two points that are respectively located on the two sides of the reference point E and are 3 mm away from the reference point E presents a concave arc towards the interior of the sound-generating portion 210, while effectively ensuring a depth of a concavity of the sub-segment between the reference point E and the reference point P1 towards the interior of the sound-generating portion 210, thereby effectively preventing the pressure relief hole 330 disposed within the sub-segment between the reference point E and the reference point P1 from being blocked by the ear or the sound-generating portion 210.

In some embodiments, the arc-to-chord ratio between the two points that are respectively located on the two sides of the reference point E and are 3 mm away from the reference point E is set to 1.352. Based on this, the inner contour 300 between the two points that are respectively located on the two sides of the reference point E and are 3 mm away from the reference point E presents the concave arc towards the interior of the sound-generating portion 210, while effectively ensuring the depth of concavity of the sub-segment between the reference point E and the reference point P1 towards the interior of the sound-generating portion 210, thereby effectively preventing the pressure relief hole 330 disposed within the sub-segment between the reference point E and the reference point P1 from being blocked by the ear or the sound-generating portion 210.

In some embodiments, further referring to FIGS. 5-7, a shortest connecting line exists between the outer wall surface of the sound-generating portion 210 and the outer wall surface of the abutment portion 220. A midpoint of the shortest connecting line serves as the reference point O. A connecting line CO is formed between the reference point C and the reference point O. The connecting line CO is located between the connecting line CL and the connecting line CH. A length of the connecting line CO is in a range of 15 mm to 20 mm, e.g., 15.3 mm, 15.8 mm, 16.1 mm, 16.5 mm, 17 mm, 17.7 mm, 18.3 mm, 18.6 mm, 19.2 mm, or 19.5 mm. An angle R3 between the connecting line CO and the connecting line CL is in a range of 9° to 19°, e.g., 12°, 15°, or 17°. In some embodiments, the length of the connecting line CO may also be set in a range of 15 mm to 19.6 mm, which falls within the range of 15 mm to 20 mm.

In some embodiments, as explained above, the outer wall surface of the sound-generating portion 210 and the outer wall surface of the abutment portion 220 do not contact each other. Therefore, the shortest connecting line exists between the outer wall surface of the sound-generating portion 210 and the outer wall surface of the abutment portion 220, and the length of the shortest connecting line is not 0. At this time, the reference point O is the midpoint of the shortest connecting line Q1Q2. More descriptions regarding the details of the embodiment herein may be found in the explanation above, which will not be repeated here. In some embodiments, the outer wall surface of the sound-generating portion 210 and the outer wall surface of the abutment portion 220 contact each other. Therefore, the length of the shortest connecting line between the outer wall surface of the sound-generating portion 210 and the outer wall surface of the abutment portion 220 is nearly 0. At this time, the reference point O may be a midpoint of an arc line Q3Q4 formed by the abutment region between the outer wall surface of the sound-generating portion 210 and the outer wall surface of the abutment portion 220. More descriptions regarding the details of the embodiment herein may be found in the explanation above, which will not be repeated here.

The length of the connecting line CO is set in a range of 15 mm to 20 mm or in a range of 15 mm to 19.6 mm, and the angle R3 between the connecting line CO and the connecting line CL is set in a range of 9° to 19°. Based on this, the sound-generating portion 210 and the abutment portion 220 can effectively and fully clamp the helix E17 under the action of the ear hook 230, thereby effectively improving the fixation effect between the earphone 200 and the ear. For example, the length of the connecting line CO is set to 17.35 mm, and the angle R3 between the connecting line CO and the connecting line CL is set to 14°.

In some embodiments, further referring to FIG. 5, an angle R4 between the connecting line CO and the connecting line CE is in a range of 15° to 27°, e.g., 17°, 19°, 22°, 24°, or 26°. Based on this, the inner contour 300 of the earphone 200 is enabled to better bypass the helix E17, the contact between the inner contour 300 of the earphone 200 and the helix E17 is reduced, and the matching between the inner contour 300 and the physiological structures of the helix E17 and the cavum conchae E12 is also improved, to reduce the overall volume of the earphone 200, thereby effectively improving the wearing comfort and wearing stability of the earphone 200. For example, the angle R4 between the connecting line CO and the connecting line CE may be set to 21°.

In some embodiments, further referring to FIG. 7, in some embodiments, the angle R4 between the connecting line CO and the connecting line CH is in a range of 25° and 50°. Based on this, the inner contour 300 of the earphone 200 is enabled to better bypass the helix E17, the contact between the inner contour 300 of the earphone 200 and the helix E17 is reduced, and the matching between the inner contour 300 and the physiological structures of the helix E17 and the cavum conchae E12 is also improved, to reduce the overall volume of the earphone 200, thereby effectively improving the wearing comfort and wearing stability of the earphone 200. For example, the angle R4 between the connecting line CO and the connecting line CH may be set to 43°.

In some embodiments, further referring to FIG. 7, the connecting line CL is located between the connecting line CE and the connecting line CO. The angle R3 between the connecting line CL and the connecting line CO is in a range of 9° to 19°, e.g., 11°, 13°, 16°, or 18°. Based on this, the sound-generating portion 210 can be fully placed within the cavum conchae E12 while the inner contour 300 does not contact or squeeze the helix E17, thereby effectively improving the wearing comfort of the earphone 200 and also effectively improving the sound transmission quality of the earphone 200. For example, the angle R3 between the connecting line CL and the connecting line CO may be set to 14°.

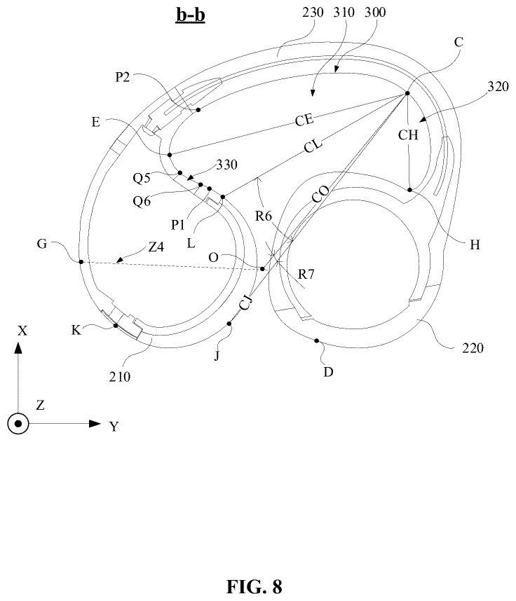

In some embodiments, referring to FIG. 8, the sound-generating portion 210 includes a reference point J. A connecting line CJ is formed between the reference point C and the reference point J. The connecting line CJ is tangent to the sound-generating portion 210 and is located between the connecting line CO and the connecting line CH. A length of the connecting line CJ is in a range of 16 mm to 23 mm, e.g., 17 mm, 17.6 mm, 18 mm, 20 mm, or 22 mm. An angle R6 between the connecting line CJ and the connecting line CL is in a range of 11° to 21°, e.g., 13°, 15°, 17°, 18.4°, or 19°. In some embodiments, the length of the connecting line CJ may be set in a range of 17 mm to 23 mm, which falls within the range of 16 mm to 23 mm.

In some embodiments, the reference point J is also referred to as a sixth reference point, and the connecting line CJ is also referred to as a fifth connecting line. The connecting line CJ is tangent to the sound-generating portion 210, and the reference point C corresponds to the edge 1071 of the helix E17. Therefore, in a direction from the helix E17 to the cavum conchae E12, the reference point J is the farthest point from the reference point C under the premise that the sound-generating portion 210 contact the cavum conchae E12. The length of the connecting line CJ is set in a range of 16 mm to 23 mm or in a range of 17 mm to 23 mm, and the angle R6 between the connecting line CJ and the connecting line CL is set in a range of 11° to 21°. Based on this, a contact area between the sound-generating portion 210 and the cavum conchae E12 is effectively increased, thereby effectively alleviating pressure pain on the ear when the earphone 200 is worn and consequently effectively improving the wearing comfort of the earphone 200. For example, the length of the connecting line CJ may be set to 19.7 mm or 20.2 mm, and the angle R6 between the connecting line CJ and the connecting line CL may be set to 16°.

In some embodiments, further referring to FIG. 8, an angle R7 between the connecting line CJ and the connecting line CO is in a range of 11° to 21°, e.g., 13°, 17°, 18.5°, or 20°. Based on this, the contact area between the sound-generating portion 210 and the cavum conchae E12 is effectively increased, thereby effectively alleviating the pressure pain on the ear when the earphone 200 is worn and consequently effectively improving the wearing comfort of the earphone 200. For example, the angle R7 between the connecting line CJ and the connecting line CO may be set to 16°.

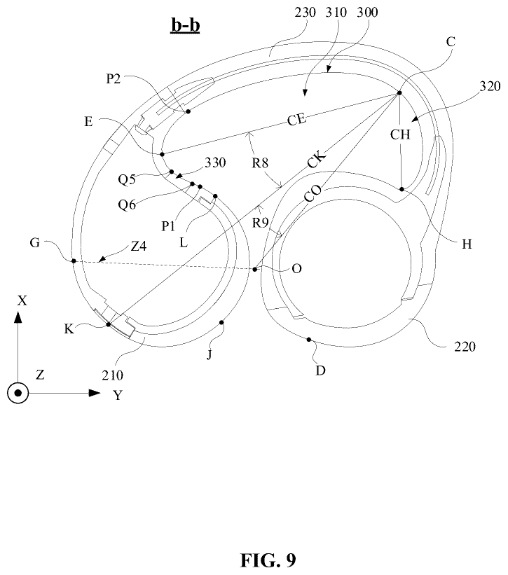

In some embodiments, referring to FIG. 9, the sound-generating portion 210 includes a reference point K that is farthest from the reference point C. A connecting line CK is formed between the reference point C and the reference point K. The connecting line CK is located between the connecting line CE and the connecting line CO. A length of the connecting line CK is in a range of 24 mm to 30 mm, e.g., 25 mm, 25.6 mm, 26.1 mm, 27 mm, 28.1 mm, or 29 mm. An angle R8 between the connecting line CK and the connecting line CE is in a range of 13° to 25°, e.g., 14°, 16°, 17.8°, 20.7°, 22°, 24°, or 24.7°. In some embodiments, the length of the connecting line CK may be set in a range of 25 mm to 30 mm, which falls within the range of 24 mm to 30 mm.

In some embodiments, the reference point K is a point on the sound-generating portion 210 that is farthest from the reference point C. In some embodiments, the reference point K is also referred to as a seventh reference point, and the connecting line CK is also referred to as a sixth connecting line.

When the earphone 200 is in the wearing state, the reference point K is closest to the ear orifice. If the reference point K is too close to the ear orifice, the ear orifice may be blocked, the user experience may be affected. If the reference point K is too far from the ear orifice, the sound transmission effect of the earphone 200 may be affected. Therefore, the length of the connecting line CK is set in a range of 24 mm to 30 mm or in a range of 25 mm to 30 mm, and the angle R8 between the connecting line CK and the connecting line CE is set in a range of 13° to 25°. Based on this, a region of the sound-generating portion 210 close to the reference point K may maintain a suitable distance from the ear orifice when the sound-generating portion 210 extends into the cavum conchae E12, thereby effectively preventing the sound-generating portion 210 from blocking the ear orifice and effectively improving the sound transmission effect of the earphone 200. For example, the length of the connecting line CK may be set to 27.7 mm, and the angle R8 between the connecting line CK and the connecting line CE may be set to 20°.

In some embodiments, further referring to FIG. 9, an angle R9 between the connecting line CK and the connecting line CO is in a range of 10° to 20°, e.g., 13°, 15°, 17°, or 18°. Based on this configuration, when the sound-generating portion 210 extends into the cavum conchae E12, the region of the sound-generating portion 210 close to the reference point K maintains a suitable distance from the ear orifice, thereby effectively preventing the sound-generating portion 210 from blocking the ear orifice while effectively improving the sound transmission effect of the earphone 200. For example, the angle R9 between the connecting line CK and the connecting line CO may be set to 15°.

In some embodiments, an arc-to-chord ratio of the outer wall surface of the sound-generating portion 210 between the reference point L and the reference point K and facing towards the abutment portion 220 is in a range of 1.4 to 1.7, e.g., 1.5, 1.6, or 1.65. Based on this configuration, a side of the sound-generating portion 210 towards the abutment portion 220 becomes more spherical. The outer wall surface of the sound-generating portion 210 between the reference point L and the reference point K and facing towards the abutment portion 220 is a continuous curved surface convex towards the abutment portion. In some embodiments, the arc-to-chord ratio of the outer wall surface of the sound-generating portion 210 may also be set in a range of 1.5 to 1.67, which falls within the range of 1.4 to 1.7. For example, the arc-to-chord ratio of the outer wall surface of the sound-generating portion 210 between the reference point L and the reference point K and facing towards the abutment portion 220 may be set to 1.64.

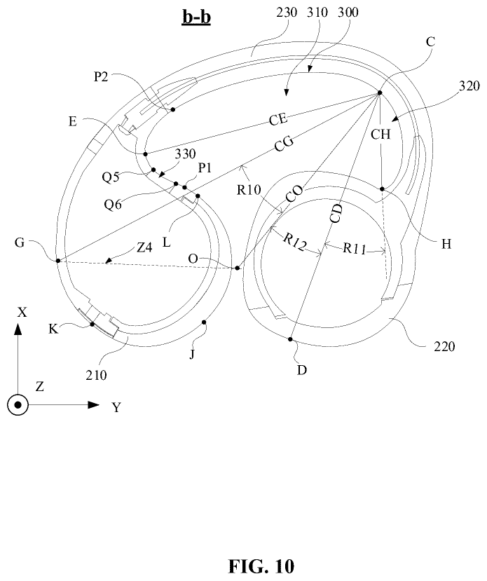

In some embodiments, referring to FIG. 10, the sound-generating portion 210 includes a reference point G close to the tragus E19. A connecting line CG is formed between the reference point C and the reference point G. The connecting line CG is located between the connecting line CE and the connecting line CO. An angle R10 between the connecting line CG and the connecting line CO is in a range of 20° to 25°, e.g., 21°, 23°, 24°, or 24.5°. A length of the connecting line CG is in a range of 23 mm to 31 mm, e.g., 25 mm, 27 mm, 28 mm, or 30 mm.

In some embodiments, further referring to FIG. 3, FIG. 4, and FIG. 10, the reference point G refers to a reference point of the sound-generating portion 210. In some embodiments, the reference point G is also referred to as an eighth reference point, and the connecting line CG is also referred to as a seventh connecting line. When the earphone 200 is in the wearing state, the reference point G is disposed close to the tragus E19. Therefore, if the reference point G is too close to the tragus E19 or contacts the tragus E19, the sound-generating portion 210 may block the ear orifice to some extent, thereby affecting the user experience. Therefore, the length of the connecting line CG is set in a range of 23 mm to 30 mm, and the angle R10 between the connecting line CG and the connecting line CO is set in a range of 12° to 20°. Based on this, when the sound-generating portion 210 extends into the cavum conchae E12, a region of the sound-generating portion 210 close to the reference point G maintains a moderate distance from the tragus E19, thereby effectively preventing the sound-generating portion 210 from blocking the ear orifice. For example, the angle R10 between the connecting line CG and the connecting line CO is set to 18°, and the length of the connecting line CG is set to 27.12 mm. As another example, the angle R10 between the connecting line CG and the connecting line CO is set to 23°.

In some embodiments, the shortest connecting line Q1Q2 between the outer wall surface of the sound-generating portion 210 and the outer wall surface of the abutment portion 220 includes an extension line Z4 extending away from the abutment portion 220 or towards the abutment portion 220. An intersection point between the extension line Z4 and the outer wall surface of the sound-generating portion 210 at a side facing away from the abutment portion 220 is the reference point G.

In some embodiments, further referring to FIG. 3, FIG. 4, and FIG. 10, the abutment portion 220 includes a reference point D that is farthest from the reference point C. A connecting line CD is formed between the reference point C and the reference point D. The connecting line CD is located between the connecting line CE and the connecting line CH. A length of the connecting line CD is in a range of 16 mm and 25 mm, e.g., 18 mm, 17 mm, 19.5 mm, 21 mm, 23 mm, or 24 mm. An angle R11 between the connecting line CD and the connecting line CH is in a range of 15° to 26°, e.g., 16°, 18°, 21°, 23°, or 24°. In some embodiments, the length of the connecting line CD is in a range of 16 mm to 24 mm, which falls within the range of 16 mm to 25 mm.

In some embodiments, further referring to FIG. 3, FIG. 4, and FIG. 10, the reference point D is a reference point on the abutment portion 220 that is farthest from the reference point C. When the earphone 200 is in the wearing state, the reference point D is a reference point on the abutment portion 220 that is closest to a skull portion 400 at a back side of the helix E17. To effectively improve the wearing comfort of the earphone 200, the contact between the abutment portion 220 and the skull portion 400 at the back side of the helix E17 should be avoided as much as possible. Therefore, the length of the connecting line CD is set in a range of 16 mm to 24 mm or in a range of 16 mm to 25 mm, and the angle R11 between the connecting line CD and the connecting line CH is set in a range of 15° to 26°. Based on this, a portion of the abutment portion 220 close to the reference point D is effectively prevented from contacting or abutting the skull portion 400 at the back side of the helix E17, thereby effectively improving the wearing comfort of the earphone 200. For example, the length of the connecting line CD is set to 20.65 mm, and the angle R11 between the connecting line CD and the connecting line CH is set to 22° or 19°.

Furthermore, the length of the connecting line CD is set in a range of 16 mm to 24 mm or in a range of 16 mm to 25 mm, and the angle R11 between the connecting line CD and the connecting line CH is set in a range of 15° to 26°. Based on this, the applicability of the earphone 200 is also effectively improved.

For example, in the wearing state of the earphone 200 shown in FIG. 3, when a user with large ears wears the earphone 200, a minimum distance h1 exists between the abutment portion 220 and the skull portion 400. The minimum distance h1 is a straight-line distance from the reference point D to the skull portion 400. In the wearing state of the earphone 200 shown in FIG. 4, when a user with small ears wears the earphone 200, a minimum distance h2 exists between the abutment portion 220 and the skull portion 400. The minimum distance h2 is a straight-line distance from the reference point D to the skull portion 400. Due to the difference in ear size, the minimum distance h2 is smaller than the minimum distance h1. Therefore, the length of the connecting line CD is set in a range of 16 mm to 24 mm or in a range of 16 mm to 25 mm, and the angle R11 between the connecting line CD and the connecting line CH is set in a range of 15° to 26°, to ensure that even when the earphone 200 is used by the user with small ears, a sufficiently large minimum distance h2 exists between the abutment portion 220 and the user's skull portion 400, thereby effectively improving the applicability of the earphone 200.

In some embodiments, further referring to FIG. 3, FIG. 4, and FIG. 10, the connecting line CD is also located between the connecting line CO and the connecting line CH. An angle R12 between the connecting line CD and the connecting line CO is in a range of 15° to 25°, e.g., 16°, 18°, 19°, 22°, or 24°. Based on this, the portion of the abutment portion 220 close to the reference point D is effectively prevented from contacting or abutting the skull portion 400 at the back side of the helix E17, thereby effectively improving the wearing comfort of the earphone 200. For example, the angle R12 between the connecting line CD and the connecting line CO is set to 20°.

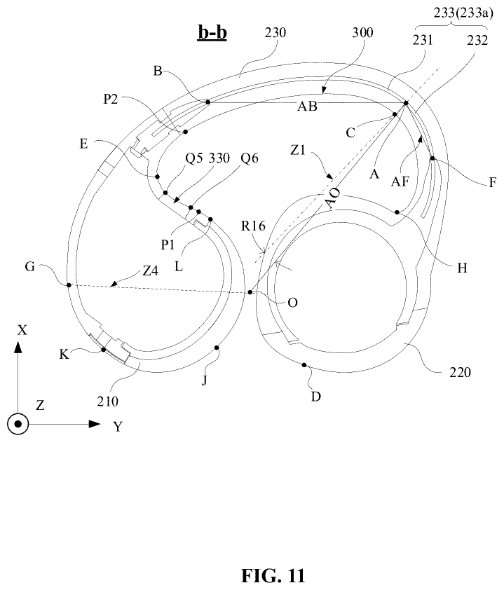

In some embodiments, referring to FIGS. 11 to 13, as described above, the earphone 200 includes the sound-generating portion 210, the abutment portion 220, and the ear hook 230. The ear hook 230 connects the sound-generating portion 210 and the abutment portion 220. In the wearing state, the sound-generating portion 210 and the abutment portion 220 form a clamping state on two sides of the helix E17 of the user, and the sound-generating portion 210 is located in the cavum conchae E12. In some embodiments, the ear hook 230 includes an elastic metal member. In a reference cross-section b-b set along a length direction of the ear hook 230 and in a natural state, the elastic metal member includes an elastic segment 233. The elastic segment 233 is further divided into a first sub-elastic segment 231 and a second sub-elastic segment 232 that are respectively arranged in an arc shape and connected to each other. The first sub-elastic segment 231 is connected to the sound-generating portion 210. The second sub-elastic segment 232 is connected to the abutment portion 220. In a direction away from a connection point A of the first sub-elastic segment 231 and the second sub-elastic segment 232, a curvature radius of at least a portion of the first sub-elastic segment 231 starting from the connection point A and a curvature radius of at least a portion of the second sub-elastic segment 232 starting from the connection point A gradually increase. A length of the first sub-elastic segment 231 is greater than a length of the second sub-elastic segment 232. At a first endpoint B of the first sub-elastic segment 231 away from the connection point A, the first sub-elastic segment 231 has a first curvature radius. At a second endpoint F of the second sub-elastic segment 232 away from the connection point A, the second sub-elastic segment 232 has a second curvature radius. The first curvature radius is greater than the second curvature radius.

In some embodiments, the reference point C is located on a normal direction Z1. The normal direction Z1 is a direction collinear with a normal of the ear hook 230 at the connection point A. The first sub-elastic segment 231 is located in a region between the reference point C and the reference point E. The second sub-elastic segment 232 is located in a region between the reference point C and the reference point H. Therefore, when the earphone 200 is in the wearing state, the connection point A is located at a position corresponding to the edge 1071 of the helix E17. The connection point A is a mutation point of the curvature radius of the elastic segment 233. The elastic segment 233 is divided into the first sub-elastic segment 231 and the second sub-elastic segment 232 at the connection point A. The first sub-elastic segment 231 and the second sub-elastic segment 232 are arranged in the above manner, so that the elastic segment 233 better matches the physiological structures of the helix E17 and the cavum conchae E12, thereby effectively improving the clamping effect of the elastic segment 233 and further effectively improving the wearing stability of the earphone 200. Moreover, the first endpoint B is an endpoint where the first sub-elastic segment 231 is connected to the sound-generating portion 210, and the second endpoint F is an endpoint where the second sub-elastic segment 232 is connected to the abutment portion 220. Since a contour at a connection between the helix E17 and the cavum conchae E12 has a mutation point, the first curvature radius is set at the first endpoint B and the second curvature radius is set at the second endpoint F, so that the elastic segment 233 better matches the physiological structures of the helix E17 and the cavum conchae E12, thereby effectively improving the clamping effect of the elastic segment 233 and further effectively improving the wearing stability of the earphone 200.

In some embodiments, referring to FIGS. 11 to 13, in a direction away from the connection point A and between the connection point A and the first endpoint B, the curvature radius of the first sub-elastic segment 231 gradually increases. In the direction away from the connection point A and between the connection point A and the second endpoint F, the curvature radius of the second sub-elastic segment 232 gradually increases. Based on this, while the elastic segment 233 better matches the physiological structures of the helix E17 and the cavum conchae E12, the structural complexity of the elastic segment 233 is effectively reduced, thereby effectively improving the processing efficiency of the elastic segment 233.

In some embodiments, a connecting line AB is formed between the connection point A and the first endpoint B. A length of the connecting line AB is in a range of 10 mm to 18 mm. For example, the length of the connecting line AB may be 10 mm, 12 mm, 14 mm, 16 mm, or 18 mm. The first sub-elastic segment 231 is located at an outer side of the connecting line AB. A connecting line AF is formed between the connection point A and the second endpoint F. A length of the connecting line AF is in a range of 2 mm to 9 mm. For example, the length of the connecting line AF may be 2 mm, 3 mm, 4 mm, 5 mm, 6 mm, 7 mm, 8 mm, etc. The second sub-elastic segment 232 is located at an outer side of the connecting line AF.

In some embodiments, the connecting line AB is also referred to as a first connecting line formed between the connection point A and the first endpoint B. The connecting line AF is also referred to as a second connecting line formed between the connection point A and the second endpoint F. If the connecting line AB and the connecting line AF are too short, the stiffness of the first sub-elastic segment 231 and the second sub-elastic segment 232 may be relatively large, resulting in difficulty for the elastic segment 233 to elastically deform to generate a clamping force. If the connecting line AB and the connecting line AF are too long, the stiffness of the first sub-elastic segment 231 and the second sub-elastic segment 232 may be relatively small, resulting in a relatively small clamping force of the elastic segment 233, which is not conducive to clamping and fixing of the earphone 200. Therefore, the length of the connecting line AB is set in a range of 10 mm to 18 mm, and the length of the connecting line AF is set in a range of 2 mm to 9 mm. Based on this, the length of the first sub-elastic segment 231 and the length of the second sub-elastic segment 232 fall within a relatively moderate range, so that the elastic segment 233 easily generates the clamping force while effectively increasing the clamping force, thereby effectively improving the clamping effect of the elastic segment 233 to effectively improve the wearing stability of the earphone 200. For example, the length of the connecting line AB is set to 14.94 mm, and the length of the connecting line AF is set to 6.16 mm.

In some embodiments, an arc-to-chord ratio of the first sub-elastic segment 231 is in a range of 1.01 to 1.1, e.g., 1.01, 1.02, 1.03, 1.04, 1.05, 1.08, etc. In some embodiments, an arc-to-chord ratio of the second sub-elastic segment 232 is in a range of 1.01 to 1.12, e.g., 1.01, 1.02, 1.03, 1.04, 1.05, 1.065, 1.07, 1.2, etc. Based on this, the clamping effect of the elastic segment 233 is further improved, thereby effectively improving the wearing stability of the earphone 200. A contour shape of the first sub-elastic segment 231 in the reference cross-section b-b is a continuous arc protruding away from the connecting line AB. A contour shape of the second sub-elastic segment 232 in the reference cross-section b-b is a continuous arc protruding away from the connecting line AF. For example, the arc-to-chord ratio of the first sub-elastic segment 231 is set to 1.08, and the arc-to-chord ratio of the second sub-elastic segment 232 is set to 1.05.

In some embodiments, at the connection point A, the ear hook 230 has a third curvature radius. The third curvature radius is in a range of 4 mm to 7 mm, e.g., 4.3 mm, 5.1 mm, 6 mm, 6.4 mm, etc. A difference between the first curvature radius and the third curvature radius is in a range of 10 mm to 25 mm, e.g., 12 mm, 15 mm, 17 mm, 19 mm, 20 mm, 23 mm, etc. A difference between the second curvature radius and the third curvature radius is in a range of 1 mm to 5 mm, e.g., 1 mm, 2 mm, 3 mm, 4 mm, or 5 mm. Based on this, the clamping effect of the elastic segment 233 is further improved, thereby further improving the wearing stability of the earphone 200. For example, the third curvature radius is set to 4.88 mm, the difference between the first curvature radius and the third curvature radius is set to 13 mm, and the difference between the second curvature radius and the third curvature radius is set to 3.95 mm.

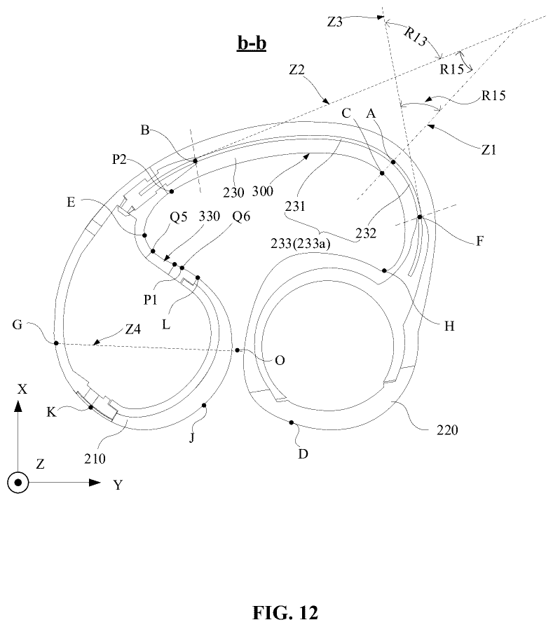

In some embodiments, further referring to FIG. 12, at the first endpoint B, the first sub-elastic segment 231 has a first tangential direction Z2. At the second endpoint F, the second sub-elastic segment 232 has a second tangential direction Z3. An angle R13 between the first tangential direction Z2 and the second tangential direction Z3 is in a range of 43° to 100°, e.g., 45°, 50°, 55°, 63°, 67°, 80°, 90°, 100°, etc. Based on this, an overall structure of the elastic segment 233 is enabled to better match the physiological structures of the helix E17 and the cavum conchae E12, thereby further improving the wearing comfort of the earphone 200 while further improving the clamping effect of the elastic segment 233 to further improve the wearing stability of the earphone 200. For example, the angle R13 between the first tangential direction Z2 and the second tangential direction Z3 is set to 53°. Certainly, the first tangential direction Z2 may also be tangent to an outer contour of the ear hook 230 on the reference cross-section b-b. In some embodiments, a point on the outer contour of the ear hook 230 corresponding to the first endpoint B in the first tangential direction Z2 (e.g., an intersection point of a normal passing through the first endpoint B with the outer contour) is tangent to the outer contour. Similarly, the second tangential direction Z3 may also be tangent to the outer contour of the ear hook 230 on the reference cross-section b-b. In some embodiments, a point on the outer contour of the ear hook 230 corresponding to the second endpoint F in the second tangential direction Z3 (e.g., an intersection point of a normal passing through the second endpoint F with the outer contour) is tangent to the outer contour.

In some embodiments, further referring to FIG. 12, the ear hook 230 has the normal direction Z1. An angle R14 between the first tangential direction Z2 and the normal direction Z1 is in a range of 15° to 41°, e.g., 17°, 19°, 23°, 25°, 29°, 32°, 36°, 38°, 41°, etc. An angle R15 between the second tangential direction Z3 and the normal direction Z1 is in a range of 24° to 80°, e.g., 26°, 29°, 31°, 33°, 40°, 50°, 60°, 70°, or 80°. Based on this, the overall structure of the elastic segment 233 is enabled to better match the physiological structures of the helix E17 and the cavum conchae E12, thereby further improving the wearing comfort of the earphone 200 while further improving the clamping effect of the elastic segment 233 to further improve the wearing stability of the earphone 200. For example, the angle R14 between the first tangential direction Z2 and the normal direction Z1 is set to 27°, and the angle R15 between the second tangential direction Z3 and the normal direction Z1 is set to 30°.

In some embodiments, further referring to FIG. 11, a shortest connecting line exists between the outer wall surface of the sound-generating portion 210 and the outer wall surface of the abutment portion 220. An angle R16 between a connecting line AO and the normal direction Z1 is in a range of 0° to 10°, e.g., in a range of 0° to 8°. The connecting line AO is a connecting line between a midpoint of the shortest connecting line (i.e., the reference point O) and the connection point A. For example, the angle R16 may be 2°, 4°, 5°, 7°, etc. Based on this, the overall structure of the elastic segment 233 is enabled to better match the physiological structures of the helix E17 and the cavum conchae E12, thereby further improving the wearing comfort of the earphone 200 while further improving the clamping effect of the elastic segment 233 to further improve the wearing stability of the earphone 200. For example, the angle R16 may be set to 1.08°.

As shown in FIG. 6, in some embodiments, the outer wall surface of the sound-generating portion 210 and the outer wall surface of the abutment portion 220 contact each other. An arc formed by the abutment region in the reference cross-section has a midpoint (i.e., the reference point O). The angle R16 between the connecting line AO from the midpoint O to the connection point A and the normal direction Z1 is in a range of 0° to 10°, e.g., in a range of 0° to 8°. For example, the angle R16 may be 2°, 4°, 5°, 7°, etc. Based on this, the overall structure of the elastic segment 233 better matches the physiological structures of the helix E17 and the cavum conchae E12, thereby further improving the wearing comfort of the earphone 200 while further enhancing the clamping effect of the elastic segment 233, to further improve the wearing stability of the earphone 200.

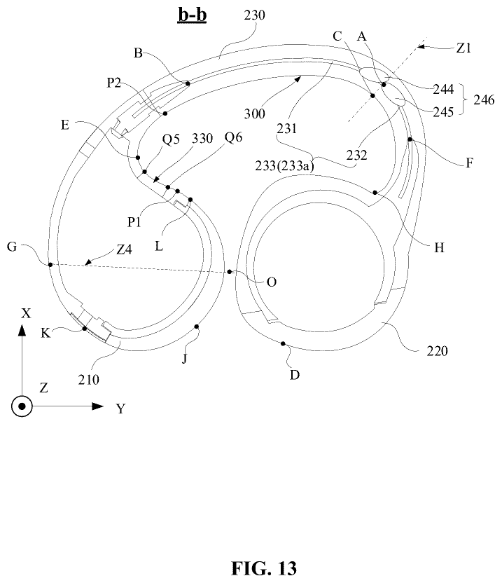

In some embodiments, further referring to FIG. 13, the ear hook 230 includes a bistable structure 246. The bistable structure 246 is disposed on the elastic segment 233. The bistable structure 246 is configured to enable the ear hook 230 to have a first stable position and a second stable position. A minimum distance between the sound-generating portion 210 and the abutment portion 220 when the ear hook 230 is in the first stable position is greater than a minimum distance between the sound-generating portion 210 and the abutment portion 220 when the ear hook 230 is in the second stable position.

In some embodiments, the bistable structure 246 is disposed on the elastic segment 233 and is configured to enable the elastic segment 233 to maintain a fixed shape in the first stable position and the second stable position, so that the sound-generating portion 210 and the abutment portion 220 may maintain corresponding minimum distances when the ear hook 230 is in corresponding stable positions, thereby effectively improving wearing convenience of the earphone 200. For example, when a user needs to wear the earphone 200, the user may pre-adjust the ear hook 230 to the first stable position, so that a sufficiently large spacing is maintained between the sound-generating portion 210 and the abutment portion 220. After the earphone 200 is worn on a corresponding position of an ear, a shape fixing function of the bistable structure 246 is canceled to restore a normal clamping function of the ear hook 230. As another example, when the user does not need to wear the earphone 200, the ear hook 230 is automatically or manually adjusted to a stable position where the minimum distance exists between the sound-generating portion 210 and the abutment portion 220 without a direct contact, i.e., the second stable position. Based on this, it is possible to effectively prevent the sound-generating portion 210 and the abutment portion 220 from colliding violently due to the elasticity of the ear hook 230 after the user removes the earphone 200 from the ear, thereby effectively improving the service life of the earphone 200. In some embodiments, by setting a spacing of accommodation positions in a battery case, the earphone 200 is set in the first stable position when placed in the battery case, or the earphone 200 may be pressed by a cover of the battery case to maintain in the first stable position when the cover is closed. Thus, the user only needs to press the earphone tightly to maintain the earphone in the second stable position after wearing the earphone on the helix. During this process, only one operation is required, and convenience of use is improved.

In some embodiments, further referring to FIG. 13, the bistable structure 246 includes a protruding portion 245 and an abutment member 244 that are connected to the elastic segment 233 at intervals. The abutment member 244 abuts against a protrusion point of the protruding portion 245. The first stable position and the second stable position are formed when the abutment member 244 abuts against two sides of the protrusion point, respectively. The two sides of the protrusion point refer to two sides of the protrusion point along the normal direction Z1. In some embodiments, the bistable structure 246 may be disposed at a position on the elastic segment 233 corresponding to the reference point C. The abutment member 244 and the protruding portion 245 are disposed on two sides of the position on the elastic segment 233 corresponding to the reference point C along an extending direction of the elastic segment 233, respectively. This configuration positions the bistable structure 246 in a region of the ear hook 230 close to the helix, facilitating the user operation. Furthermore, the position is a main deformation region of the elastic segment 233 and is relatively central, less prone to stress concentration and fatigue.

In some embodiments, in the natural state, the sound-generating portion 210 and the abutment portion 220 abut against each other under the action of the ear hook 230. In some embodiments, in the natural state, after the action of the ear hook 230, the sound-generating portion 210 and the abutment portion 220 may also not abut against each other. More descriptions regarding the embodiment of the details may be found in the content described above, which will not be repeated in detail herein.

In some embodiments, the reference cross-section b-b refers to a symmetry plane of the ear hook 230.

In some embodiments, the elastic metal member is an elastic metal wire, and the symmetry plane of the ear hook 230 is a plane in which a central axis of the elastic metal wire lies.

In some embodiments, the elastic metal member is an elastic metal sheet 233a. Two opposite ends of the elastic metal sheet 233a along a length direction are connected to the sound-generating portion 210 and the abutment portion 220, respectively. In the wearing state, a thickness direction of the elastic metal sheet 233a faces towards or away from the helix E17, and the symmetry plane of the ear hook 230 bisects the elastic metal sheet 233a along a width direction of the elastic metal sheet 233a. Based on this, an elastic deformation trend of the elastic metal sheet 233a can better conform to the physiological structures of the helix E17 and the cavum conchae E12, thereby effectively improving the wearing stability and wearing comfort of the earphone 200.

In some embodiments, between the first endpoint B and the second endpoint F, a width-to-thickness ratio of the elastic metal sheet 233a is in a range of 8 to 12, e.g., 9, 10, or 11. Based on this, the width-to-thickness ratio of the elastic metal sheet 233a is set in a range of 8 to 20, which can effectively provide the elastic metal sheet 233a with good elasticity, thereby effectively improving the elasticity of the ear hook 230, and effectively improving the wearing stability and wearing comfort of the earphone 200. For example, the width-to-thickness ratio of the elastic metal sheet 233a may be 8, 10, 12, 14, 17, 19, or 20.

For example, a width of the elastic metal sheet 233a is set to 2 mm, and a thickness of the elastic metal sheet 233a is set to 0.2 mm.

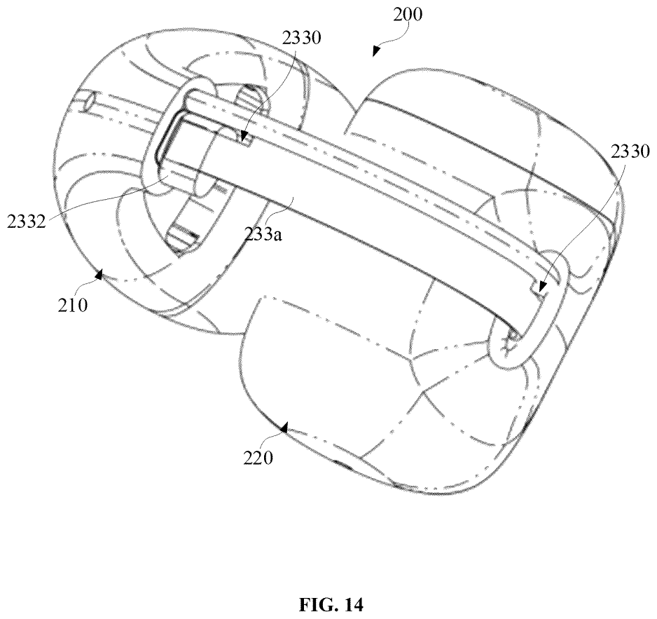

In some embodiments, the earphone 200 further includes a flexible printed circuit board (FPC). The FPC is arranged along a length direction of the elastic metal member and disposed on the elastic metal member. Based on this, wiring difficulty on the earphone 200 can be effectively reduced. For example, if the elastic metal member is the elastic metal sheet 233a, the FPC may extend substantially along an upper surface or a lower surface of the elastic metal sheet. As shown in FIG. 14, the elastic metal member may be the elastic metal sheet 233a. Two ends of the elastic metal sheet 233a may be provided with plug blocks 2332. The plug blocks 2332 at the two ends may be plug-connected to the sound-generating portion 210 and the abutment portion 220, respectively. The elastic metal sheet 233a is provided with notches 2330 close to the plug blocks 2332, respectively. The notches 2330 extend in the width direction through side edges of the elastic metal sheet 233a, respectively. The notches 2330 facilitate glue sealing, resulting in better injection molding effects.

The foregoing descriptions are merely a portion of embodiments of the present disclosure, and are not intended to limit the protection scope of the present disclosure. Any equivalent device or equivalent process transformation made based on the specification and drawings of the present disclosure, or direct or indirect application in other related technical fields, shall similarly fall within the patent protection scope of the present disclosure.

Some embodiments of the present disclosure provide an earphone. The earphone includes a sound-generating portion configured to convert an electrical signal into a sound signal and play the sound signal; an abutment portion provided with a battery; and an ear hook connecting the sound-generating portion and the abutment portion. In a wearing state of the earphone, the sound-generating portion and the abutment portion form a clamping state on two sides of a helix of a user, the sound-generating portion is located within a cavum conchae of the user. The ear hook includes an elastic metal member. In a reference cross-section along a length direction of the ear hook and in a natural state of the earphone, the elastic metal member includes an elastic segment. The elastic segment is divided into a first sub-elastic segment and a second sub-elastic segment that are arranged in an arc shape and connected to each other, the first sub-elastic segment is connected to the sound-generating portion, and the second sub-elastic segment is connected to the abutment portion. In a direction away from a connection point of the first sub-elastic segment and the second sub-elastic segment, a curvature radius of at least a portion of the first sub-elastic segment starting from the connection point and a curvature radius of at least a portion of the second sub-elastic segment starting from the connection point gradually increase. A length of the first sub-elastic segment is greater than a length of the second sub-elastic segment. The first sub-elastic segment has a first curvature radius at a first endpoint of the first sub-elastic segment away from the connection point, the second sub-elastic segment has a second curvature radius at a second endpoint of the second sub-elastic segment away from the connection point, and the first curvature radius is greater than the second curvature radius.

In some embodiments, a length of a first connecting line between the connection point and the first endpoint is in a range of 12 mm to 18 mm, the first sub-elastic segment is located at an outer side of the first connecting line, and a length of a second connecting line between the connection point and the second endpoint is in a range of 4 mm to 9 mm, and the second sub-elastic segment is located at an outer side of the second connecting line.

In some embodiments, an arc-to-chord ratio of the first sub-elastic segment is in a range of 1.03 to 1.1, and an arc-to-chord ratio of the second sub-elastic segment is in a range of 1.04 to 1.12.

In some embodiments, at the connection point, the ear hook has a third curvature radius in a range of 4 mm to 7 mm, a difference between the first curvature radius and the third curvature radius is in a range of 10 mm to 25 mm, and a difference between the second curvature radius and the third curvature radius is in a range of 1.5 mm to 5 mm.

In some embodiments, in a direction away from the connection point and between the connection point and the first endpoint, a curvature radius of the first sub-elastic segment gradually increases, and in the direction away from the connection point and between the connection point and the second endpoint, a curvature radius of the second sub-elastic segment gradually increases.

In some embodiments, the first sub-elastic segment has a first tangential direction at the first endpoint, the second sub-elastic segment has a second tangential direction at the second endpoint, and an angle between the first tangential direction and the second tangential direction is in a range of 43° to 68°.

In some embodiments, the ear hook has a normal direction at the connection point, an angle between the first tangential direction and the normal direction is in a range of 15° to 33°, and an angle between the second tangential direction and the normal direction is in a range of 24° to 35°.

In some embodiments, a shortest connecting line exists between an outer wall surface of the sound-generating portion and an outer wall surface of the abutment portion, the shortest connecting line has a midpoint, and an angle between a connecting line of the midpoint of the shortest connecting line and the connection point and the normal direction in a range of 0° to 8°.

In some embodiments, the ear hook includes a bistable structure disposed on the elastic segment and configured to enable the ear hook to have a first stable position and a second stable position, and a minimum distance between the sound-generating portion and the abutment portion when the ear hook is in the first stable position is greater than a minimum distance between the sound-generating portion and the abutment portion when the ear hook is in the second stable position.

In some embodiments, the bistable structure includes a protruding portion and an abutment member that are connected to the elastic segment at intervals, the abutment member abuts against a protrusion point of the protruding portion, and the first stable position and the second stable position are formed when the abutment member abuts against two sides of the protrusion point, respectively.

In some embodiments, in the natural state of the earphone, the sound-generating portion and the abutment portion abut against each other under an action of the ear hook.

In some embodiments, the reference cross-section is a symmetry plane of the ear hook.

In some embodiments, the elastic metal member is an elastic metal wire, and the symmetry plane of the ear hook is a plane in which a central axis of the elastic metal wire lies.

In some embodiments, the elastic metal member is an elastic metal sheet, two opposite ends of the elastic metal sheet along a length direction of the elastic metal sheet are connected to the sound-generating portion and the abutment portion, respectively, and in the wearing state of the earphone, a thickness direction of the elastic metal sheet faces towards or away from the helix, and the symmetry plane of the ear hook bisects the elastic metal sheet along a width direction of the elastic metal sheet.

In some embodiments, a width-to-thickness ratio of the elastic metal sheet between the first endpoint and the second endpoint is in a range of 8 to 12.

1. An earphone, comprising:
a sound-generating portion configured to convert an electrical signal into a sound signal and play the sound signal;
an abutment portion provided with a battery; and
an ear hook connecting the sound-generating portion and the abutment portion, wherein:
in a wearing state of the earphone, the sound-generating portion and the abutment portion form a clamping state on two sides of a helix of a user, the sound-generating portion is located within a cavum conchae of the user,
the ear hook includes an elastic metal member, in a reference cross-section along a length direction of the ear hook and in a natural state of the earphone, the elastic metal member includes an elastic segment, the elastic segment is divided into a first sub-elastic segment and a second sub-elastic segment that are arranged in an arc shape and connected to each other, the first sub-elastic segment is connected to the sound-generating portion, and the second sub-elastic segment is connected to the abutment portion,
in a direction away from a connection point of the first sub-elastic segment and the second sub-elastic segment, a curvature radius of at least a portion of the first sub-elastic segment starting from the connection point and a curvature radius of at least a portion of the second sub-elastic segment starting from the connection point gradually increase,
a length of the first sub-elastic segment is greater than a length of the second sub-elastic segment, and
the first sub-elastic segment has a first curvature radius at a first endpoint of the first sub-elastic segment away from the connection point, the second sub-elastic segment has a second curvature radius at a second endpoint of the second sub-elastic segment away from the connection point, and the first curvature radius is greater than the second curvature radius.

2. The earphone of claim 1, wherein
a length of a first connecting line between the connection point and the first endpoint is in a range of 12 mm to 18 mm, or is greater than or equal to 10 mm and less than or equal to 12 mm, the first sub-elastic segment is located at an outer side of the first connecting line, and
a length of a second connecting line between the connection point and the second endpoint is in a range of 4 mm to 9 mm, or is greater than or equal to 2 mm and less than or equal to 4 mm, and the second sub-elastic segment is located at an outer side of the second connecting line.

3. The earphone of claim 2, wherein
an arc-to-chord ratio of the first sub-elastic segment is in a range of 1.03 to 1.1, or is greater than or equal to 1.01 and less than or equal to 1.03, and
an arc-to-chord ratio of the second sub-elastic segment is in a range of 1.04 to 1.12, or is greater than or equal to 1.01 and less than or equal to 1.04.

4. The earphone of claim 3, wherein at the connection point, the ear hook has a third curvature radius in a range of 4 mm to 7 mm,
a difference between the first curvature radius and the third curvature radius is in a range of 10 mm to 25 mm, and
a difference between the second curvature radius and the third curvature radius is in a range of 1.5 mm to 5 mm or is greater than or equal to 1 mm and less than or equal to 1.5 mm.

5. The earphone of claim 1, wherein
in a direction away from the connection point and between the connection point and the first endpoint, a curvature radius of the first sub-elastic segment gradually increases, and
in the direction away from the connection point and between the connection point and the second endpoint, a curvature radius of the second sub-elastic segment gradually increases.

6. The earphone of claim 1, wherein the first sub-elastic segment has a first tangential direction at the first endpoint, the second sub-elastic segment has a second tangential direction at the second endpoint, and an angle between the first tangential direction and the second tangential direction is in a range of 43° to 68°, or is greater than or equal to 68° and less than or equal to 100°.

7. The earphone of claim 6, wherein the ear hook has a normal direction at the connection point, an angle between the first tangential direction and the normal direction is in a range of 15° to 33°, or is greater than or equal to 33° and less than or equal to 41°, and an angle between the second tangential direction and the normal direction is in a range of 24° to 35°, or is greater than or equal to 35° and less than or equal to 80°.

8. The earphone of claim 7, wherein a shortest connecting line exists between an outer wall surface of the sound-generating portion and an outer wall surface of the abutment portion, the shortest connecting line has a midpoint, and an angle between a connecting line of the midpoint of the shortest connecting line and the connection point and the normal direction is in a range of 0° to 10°; or
the outer wall surface of the sound-generating portion and the outer wall surface of the abutment portion abut against each other, an arc formed in the reference cross-section by an abutment region of the outer wall surface of the sound-generating portion and the outer wall surface of the abutment portion has a midpoint, and an angle between a connecting line of the midpoint of the arc and the connection point and the normal direction is in a range of 0° to 10°.

9. The earphone of claim 1, wherein
the ear hook includes a bistable structure disposed on the elastic segment and configured to enable the ear hook to have a first stable position and a second stable position, and
a minimum distance between the sound-generating portion and the abutment portion when the ear hook is in the first stable position is greater than a minimum distance between the sound-generating portion and the abutment portion when the ear hook is in the second stable position.

10. The earphone of claim 9, wherein the bistable structure includes a protruding portion and an abutment member that are connected to the elastic segment at intervals, the abutment member abuts against a protrusion point of the protruding portion, and the first stable position and the second stable position are formed when the abutment member abuts against two sides of the protrusion point, respectively.

11. The earphone of claim 1, wherein in the natural state of the earphone, the sound-generating portion and the abutment portion abut against each other under an action of the ear hook.

12. The earphone of claim 1, wherein the reference cross-section is a symmetry plane of the ear hook.

13. The earphone of claim 12, wherein the elastic metal member is an elastic metal wire, and the symmetry plane of the ear hook is a plane in which a central axis of the elastic metal wire lies.

14. The earphone of claim 12, wherein
the elastic metal member is an elastic metal sheet, two opposite ends of the elastic metal sheet along a length direction of the elastic metal sheet are connected to the sound-generating portion and the abutment portion, respectively, and
in the wearing state of the earphone, a thickness direction of the elastic metal sheet faces towards or away from the helix, and the symmetry plane of the ear hook bisects the elastic metal sheet along a width direction of the elastic metal sheet.

15. The earphone of claim 14, wherein a width-to-thickness ratio of the elastic metal sheet between the first endpoint and the second endpoint is in a range of 8 to 12, or is greater than or equal to 12 and less than or equal to 20.

16. The earphone of claim 1, further comprising a flexible printed circuit board arranged along a length direction of the elastic metal member and disposed on the elastic metal member.

17. The earphone of claim 1, wherein in a reference cross-section set along the length direction of the ear hook, the ear hook, the sound-generating portion, and the abutment portion define an inner contour.

18. The earphone of claim 17, wherein in the wearing state of the earphone, the inner contour includes a reference point located on the ear hook and corresponds to an edge of the helix, and a curvature radius of at least a portion of the inner contour located at the edge is configured to first gradually increase, then gradually decrease, and then gradually increase again from the reference point towards both the sound-generating portion and the abutment portion.

19. The earphone of claim 18, wherein in the natural state of the earphone, the earphone comprises a midpoint of a shortest connecting line between an outer wall surface of the sound-generating portion and an outer wall surface of the abutment portion, and a connecting line of the reference point and the midpoint is in a range of 15 mm to 20 mm.

20. The earphone of claim 18, wherein the inner contour includes another reference point at a side of the reference point towards the sound-generating portion, the reference point and the another reference point form a connecting line, and the inner contour between the reference point and the another reference point is located at an outer side of the connecting line.
